(19) United States
(12) Patent Application Publication
(10) Pub. No.: US 2019/0080051 A1
(43) Pub. Date: Mar. 14, 2019

(54) Methods And Systems For Profiling Personalized Biomarker Expression Perturbations

(71) Applicant: Northeastern University, Boston, MA (US)

(72) Inventors: Jörg Menche, Vienna (AT); Albert-László Barábasi, Brookline, MA (US)

(21) Appl. No.: 15/771,785

(22) PCT Filed: Nov. 10, 2016
(86) PCT No.: PCT/US2016/061401

§ 371 Date: Apr. 27, 2018

Related U.S. Application Data
(60) Provisional application No. 62/253,878, filed on Nov. 11, 2015.

(51) Int. Cl. G06F 19/20

(52) U.S. Cl. CPC G06F 19/24; G06F 19/18; G06F 19/22; G06F 19/12; G06F 19/20

(57) ABSTRACT

The disclosed methods and systems allow for a systematic quantification of the heterogeneity of disease states between different subjects on a molecular (e.g., gene or protein expression) level. One example embodiment of the invention is a method for determining a disease state of a patient. The method includes generating personalized biomarker expression perturbation profiles for a plurality of individual subjects with a disease. The profiles include representations of biomarker expressions that are perturbed beyond a threshold amount. The method also includes creating a disease module by combining representations of biomarkers from the personalized profiles. The disease module includes a network of representations of biomarkers having perturbations associated with the disease. The method also includes accessing biomarker data for the patient from a sample obtained from the patient and determining the disease state of the patient based on a comparison of the biomarker data and the disease module.

### RELATED APPLICATION

This application claims the benefit of U.S. Provisional Application No. 62/253,878, filed on Nov. 11, 2015. The entire teachings of the above application are incorporated herein by reference.

### BACKGROUND

Microarray techniques, and more recently, RNA sequencing, have fundamentally changed abilities to explore molecular mechanisms underlying complex diseases and are routinely used to identify disease-associated genome-wide changes in gene expression patterns. A common expectation is that identification of differentially expressed (DE) genes can help pinpoint the molecular processes perturbed in a disease, which, in turn, can be used as biomarkers for diagnosis and prognosis. However, conventional methods for differential expression analysis only allow for identification of average changes between two groups, not for identification of specific changes in a single subject.

### SUMMARY OF THE INVENTION

Methods and systems disclosed herein address the foregoing problems and allow for a systematic quantification of the heterogeneity of disease states between different subjects on a molecular (e.g., gene or protein expression) level.

In one aspect, the invention features a method of generating a disease profile, the method involving detecting differential levels of one or more analytes (e.g., mRNA, a methylated nucleotide, protein, peptide, lipid, carbohydrate, or a metabolite) in one or more case subjects relative to the levels of the analytes in one or more control subjects, thereby obtaining a set of personalized perturbation profiles for the case subjects; comparing the personalized perturbation profiles with a set of analytes whose differential presence is associated with said disease; and obtaining a set of overlapping analytes that defines the disease profile.

In another aspect, the invention features a method of generating a disease module, the method involving detecting differential expression of one or more genes in one or more case subjects relative to the expression levels of the genes in one or more control subjects, thereby obtaining a set of personalized perturbation profiles for the case subjects; comparing the personalized perturbation profiles with a set of genes whose differential expression is associated with said disease; and compiling all genes that are perturbed in at least about 20% (e.g., 30%, 40%, 50%, 60%, 70%, 80%, 90% or 100%) of case subjects, thereby defining a disease module.

In another aspect, the invention features a method of classifying the disease state of a subject, the method involving detecting differential expression of one or more analytes in a subject to obtain a personalized perturbation profile for the subject; determining the fraction of analytes from a disease module that are differentially expressed in the personalized perturbation profile for the subject, thereby characterizing the disease state of the subject.

In another aspect, the invention features a method of classifying the disease state of a subject, the method involving detecting differential expression of one or more genes in a subject to obtain a personalized perturbation profile for the subject; determining the fraction of genes from a disease module that are differentially expressed in the personalized perturbation profile for the subject, thereby characterizing the disease state of the subject.

In another aspect, the invention features a method of determining whether the subject has the disease, the method involving detecting differential expression of a plurality of genes in an individual case subject relative to the expression levels of the genes in one or more control subjects, thereby obtaining a personalized perturbation profile for the subject; compiling the personalized perturbation profile from each subject across a population of case subjects; comparing the compiled personalized perturbation profiles with a set of genes whose differential expression is associated with said disease and generating a statistical score; thereby determining whether the subject has the disease.

In another aspect, the invention features a computer-implemented method of generating a disease module, the method involving: (a) detecting differential levels of one or more analytes in one or more case subjects relative to the levels of the one or more analytes in one or more control subjects, thereby obtaining a set of personalized perturbation profiles of the one or more analytes for the case subjects; (b) comparing the personalized perturbation profiles with a set of one or more analytes whose differential presence is associated with said disease; and (c) obtaining a set of overlapping analytes that defines the disease module.

In one embodiment, step a. comprises: a. calculating a mean level of each analyte detected in the one or more control subjects; b. calculating, using the calculated mean level each analyte detected in the one or more control subjects, the deviation of the level of each analyte detected in the one or more test subjects; c. identifying, in the one or more test subjects, analytes with a deviation above or below a threshold deviation level from the calculated mean.

In another embodiment, the one or more analyte is a gene.

In another aspect, the invention features a computer-implemented method of classifying the disease state of a subject, the method involving: a. detecting differential levels of one or more genes in one or more case subjects relative to the levels of the one or more genes in one or more control subjects, thereby obtaining a set of personalized perturbation profiles of the one or more genes for the case subjects; b. comparing the personalized perturbation profiles with a set of one or more genes whose differential presence is associated with said disease; c. obtaining a set of overlapping genes that defines the disease module; and d. calculating a statistical score of the set of overlapping genes, and, based on the calculated score, classifying the disease state of the subject.

In one embodiment, step a. comprises: a. calculating a mean level of each gene detected in the one or more control subjects; b. calculating, using the calculated mean level each gene detected in the one or more control subjects, the deviation of the level of each gene detected in the one or more test subjects; c. identifying, in the one or more test subjects, genes with a deviation above or below a threshold deviation level from the calculated mean.

In another aspect, the invention features a computer-implemented method of generating a disease module, the method involving: a. detecting differential expression of a plurality of genes in an individual case subject relative to the expression levels of the plurality genes in at least one control subject, thereby obtaining a personalized perturbation profile for the subject; b. compiling the personalized perturbation profile from the individual subject across a population of case subjects; c. comparing the compiled personalized perturbation profiles with a set of genes whose differential expression is associated with said disease; and d. obtaining a set of overlapping genes from the compiled perturbation profiles that defines the disease module.

In one embodiment, step a. involves: a. calculating a mean level of each gene detected in the at least one control subject; b. calculating, using the calculated mean level each gene detected in the at least one control subject, the deviation of the level of each gene detected in the test subjects; c. identifying, in the test subjects, genes with a deviation above or below a threshold deviation level from the calculated mean.

In one embodiment, the method further includes obtaining a set of partially overlapping genes and non-overlapping genes from the compiled perturbation profiles.

In one embodiment, the method further includes calculating, based on the overlapping genes, partially overlapping genes, and non-overlapping genes, an expression heterogeneity of the disease.

In another aspect, the invention provides specifically programmed computer system comprising:

a. at least one specialized computer machine comprising:

i. a non-transient memory, electronically storing particular computer executable program code; and

ii. at least one computer processor which, when executing the particular program code, becomes a specifically programmed computer processor configured to perform at least the following operations:

a. detecting differential levels of one or more analytes in one or more case subjects relative to the levels of the one or more analytes in one or more control subjects, thereby obtaining a set of personalized perturbation profiles of the one or more analytes for the case subjects;

b. comparing the personalized perturbation profiles with a set of one or more analytes whose differential presence is associated with said disease; and

c. obtaining a set of overlapping analytes that defines the disease module.

In one embodiment, step ii. a. comprises: a. calculating a mean level of each analyte detected in the one or more control subjects; b. calculating, using the calculated mean level each analyte detected in the one or more control subjects, the deviation of the level of each analyte detected in the one or more test subjects; c. identifying, in the one or more test subjects, analytes with a deviation above or below a threshold deviation level from the calculated mean.

In one embodiment, the one or more analyte is a gene.

In another aspect, the invention provides a specifically programmed computer system comprising:

a. at least one specialized computer machine comprising:

i. a non-transient memory, electronically storing particular computer executable program code; and

ii. at least one computer processor which, when executing the particular program code, becomes a specifically programmed computer processor configured to perform at least the following operations:

a. detecting differential levels of one or more genes in one or more case subjects relative to the levels of the one or more genes in one or more control subjects, thereby obtaining a set of personalized perturbation profiles of the one or more genes for the case subjects;

b. comparing the personalized perturbation profiles with a set of one or more genes whose differential presence is associated with said disease;

c. obtaining a set of overlapping genes that defines the disease module; and

d. calculating a statistical score of the set of overlapping genes, and, based on the calculated score, classifying the disease state of the subject.

In another embodiment, step ii. a. comprises: a. calculating a mean level of each gene detected in the one or more control subjects; b. calculating, using the calculated mean level each gene detected in the one or more control subjects, the deviation of the level of each gene detected in the one or more test subjects; c. identifying, in the one or more test subjects, genes with a deviation above or below a threshold deviation level from the calculated mean.

In another aspect, the invention features a specifically programmed computer system comprising:

a. at least one specialized computer machine comprising:

i. a non-transient memory, electronically storing particular computer executable program code; and

ii. at least one computer processor which, when executing the particular program code, becomes a specifically programmed computer processor configured to perform at least the following operations:

a. detecting differential expression of a plurality of genes in an individual case subject relative to the expression levels of the plurality genes in at least one control subject, thereby obtaining a personalized perturbation profile for the subject;

b. compiling the personalized perturbation profile from the individual subject across a population of case subjects;

c. comparing the compiled personalized perturbation profiles with a set of genes whose differential expression is associated with said disease; and

d. obtaining a set of overlapping genes from the compiled perturbation profiles that defines the disease module.

In one embodiment, step ii. a. comprises: a. calculating a mean level of each gene detected in the at least one control subject; b. calculating, using the calculated mean level each gene detected in the at least one control subject, the deviation of the level of each gene detected in the test subjects; c. identifying, in the test subjects, genes with a deviation above or below a threshold deviation level from the calculated mean.

In one embodiment the specifically programmed computer system, further comprising obtaining a set of partially overlapping genes and non-overlapping genes from the compiled perturbation profiles.

In another embodiment the specifically programmed computer system, further comprising calculating, based on the overlapping genes, partially overlapping genes, and non-overlapping genes, am expression heterogeneity of the disease.

In various embodiments of the above aspect, a fraction greater than about 10%, 15%, 20%, 30%, 40%, 50%, 60%, 65%, 75%, 80%, 85%, 90%, or 95% indicates the presence of the disease in the subject. In one embodiment, the disease is a neurodegenerative disease (e.g., Parkinson's Disease or Huntington's Disease). In another embodiment, the disease is asthma. In another embodiment, the fraction defines a subset of patients within the disease module having similar personalized perturbation profiles.

Another example embodiment of the invention is a method for determining a disease state of a patient. The method includes generating personalized biomarker expression perturbation profiles for a plurality of individual subjects with a disease. The personalized biomarker expression perturbation profiles include representations of biomarkers that are perturbed beyond a threshold amount. The biomarker expression levels are associated with gene expression levels, and in some embodiments may be protein expression levels. The method further includes creating a disease module by combining representations of biomarkers from the personalized biomarker expression perturbation profiles. The disease module includes a network of representations of biomarkers having perturbations associated with the disease. The method further includes accessing biomarker data including representations of biomarker expressions for the patient from a sample obtained from the patient, and determining the disease state of the patient based on a comparison of the biomarker data and the disease module.

In some embodiments, the personalized biomarker expression perturbation profiles can be generated by comparing representations of biomarker expressions of the individual subjects with reference biomarker expression levels of a control group, and selecting for inclusion in the personalized biomarker expression perturbation profiles representations of biomarkers having expression levels exceeding corresponding biomarker expression levels of the control group by the threshold amount. Creating the disease module can include determining a number of random biomarker perturbations expected for the disease, and including a number of representations of biomarkers in the disease module that is greater than the expected number of random biomarker perturbations. Determining the disease state of the patient can include matching representations of perturbed biomarkers of the biomarker data with the representations of biomarkers of the disease module, and the method can determine that the patient has the disease if a number of representations of perturbed biomarkers of the biomarker data matching representations of biomarkers of the disease module exceeds a threshold level.

Another example embodiment of the invention is a system for determining a disease state of a patient. The system includes memory, a data source, a hardware processor in communication with the memory and the data source, and a control module in communication with the processor. The hardware processor is configured to perform a predefined set of operations in response to receiving a corresponding instruction selected from a predefined native instruction set of codes. The control module includes a first set of machine codes selected from the native instruction set for causing the hardware processor to obtain from the data source and store in the memory representations of biomarker expressions for a plurality of individual subjects with a disease. The biomarker expression levels are associated with gene expression levels, and in some embodiments may be protein expression levels. The control module further includes a second set of machine codes for causing the hardware processor to generate and store in the memory personalized biomarker expression perturbation profiles for the plurality of individual subjects. The personalized biomarker expression perturbation profiles include representations of biomarkers that are perturbed beyond a threshold amount. The control module further includes a third set of machine codes for causing the hardware processor to create and store in the memory a disease module by combining representations of biomarkers from the personalized biomarker expression perturbation profiles. The disease module includes a network of representations of biomarkers having perturbations associated with the disease. The control module further includes a fourth set of machine codes for causing the hardware processor to access from the data source biomarker data including representations of biomarker expressions for the patient from a sample obtained from the patient. The control module further includes a fifth set of machine codes for causing the hardware processor to determine the disease state of the patient based on a comparison of the biomarker data and the disease module.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a flow chart illustrating generating a disease module, according to an example embodiment of the present invention.

FIG. 2 is a flow chart illustrating classifying the disease state of a subject, according to an example embodiment of the present invention.

FIG. 3 is a flow chart illustrating determining a disease state of a patient, according to an example embodiment of the present invention.

FIG. 4 is a block diagram illustrating a system for determining a disease state of a patient, according to an example embodiment of the present invention.

FIGS. 5a-e are graphs illustrating a personalized biomarker expression analysis. FIG. 5a illustrates a distribution of expression levels for the asthma biomarker POSTN. FIG. 5b illustrates fractions of case subjects in which genes that are denominated as being differentially expressed in a standard group-wise analysis display normal expression levels, or expression levels that suggest a dys-regulation in the opposite direction. FIGS. 5c-e illustrate an approach towards individual perturbation profiles: Instead of comparing two groups of case and control subjects, compare each case subject individually with the background of control subjects (FIG. 5c). Genes whose expression level is sufficiently far from the range observed in the control subjects (FIG. 5d) are denoted as perturbed in the respective individual. Together, the perturbed genes constitute a personalized, subject specific “barcode” (FIG. 5e).

FIGS. 6a-f are graphs illustrating heterogeneity among the personalized perturbation profiles shown in FIGS. 5a-e. FIG. 6a illustrates a distribution of the number of PEEPs in which a gene appears that has been identified in a standard group-wise analysis for asthma. FIG. 6b illustrates fractions of group-wise DE genes found in the PEEPs for asthma patients. FIG. 6c illustrates pairwise overlap of the genes in the PEEPs as measured by the Jaccard index. FIG. 6d illustrates pairwise overlap of the genes in the PEEPs as measured by the number of common genes. FIG. 6e illustrates fractions of case subject pairs whose gene overlap is statistically significant (Fishers' exact test, p-value <0.05). FIG. 6f illustrates a distribution of the number of asthma patient PEEPs in which a gene appears.

FIG. 7a is a schematic diagram illustrating how the same pathway associated with a specific function may be disrupted by perturbations at different locations in different subjects.

FIG. 7b is a chart illustrating individual perturbations of asthmatic subjects within an asthma-specific pathway.

FIGS. 7c-f are charts illustrating pairwise similarities of pathway perturbations.

FIGS. 8a-f are graphs and diagrams illustrating integration of personalized expression perturbations profiles into a predictive pool of disease-associated biomarkers. FIG. 8a illustrates a distribution of the number of individual perturbation profiles in which a gene appears for control subjects. FIG. 8b illustrates a distribution of the number of individual perturbation profiles in which a gene appears for case subjects. FIG. 8c illustrates a Venn diagram of three broad gene pools compiled from genes that are in at least X individual perturbation profiles. FIG. 8d illustrates receiver operating characteristics (ROC) for a disease state classification by a fraction of the broad gene pool that is contained in a subject's perturbation profile. FIG. 8e illustrates sensitivity and specificity as a function of the fraction of broad gene pool for asthma. FIG. 8f illustrates a disease model suggested by the analysis of personalized perturbation profiles.

FIGS. 9a-r are graphs illustrating a number of properties of example biomarker expression data. FIGS. 9a-c illustrate a distribution of the expression levels across all transcripts for all subjects. FIGS. 9d-f illustrate a distribution of mean expression levels across all subjects for all transcripts. FIGS. 9g-i illustrate a distribution of the corresponding standard deviations. FIGS. 9j-l illustrate a distribution of the z-scores across all genes for all subjects. FIG. 9m-o illustrate a distribution of the number of genes in the individual perturbation profiles for different values of zₜₕᵣₑₛₕ. FIGS. 9p-r illustrate a principle component analysis (PCA) of the gene expression datasets.

FIG. 10 is a graph illustrating a distribution of Pearson correlation coefficients between z-score profiles of subject pairs in case and control groups of respective diseases.

FIGS. 11a-l are graphs illustrating example numbers of subjects in which a biomarker is perturbed. FIGS. 11a-f illustrate a distribution of the number of individual perturbation profiles in which a biomarker appears that has been identified in a standard group-wise analysis. FIGS. 11g-l illustrate a distribution of the number of individual perturbation profiles in which a biomarker appears.

FIGS. 12a-c are graphs illustrating example areas-under-the-curve (AUC) of receiver operating characteristics (ROC) for different combinations of parameters X and zₜₕᵣₑₛₕ.

FIGS. 13a and 13b are graphs illustrating comparisons between PEEP and a standard classification algorithm.

FIGS. 14a-c are graphs illustrating sample size dependence of example z-scores.

FIG. 15 is a table illustrating a number of example asthma-specific pathways. The numbers in the first column identify the pathway used in FIG. 3c. Column three gives the number of asthma patients whose perturbation profile is significantly enriched with genes from the respective pathway. Column four gives the number of patients with at least one perturbed pathway gene. Column five gives the corresponding empirical p-value as obtained from 10,000 random simulations, where for each subject the same number of genes have been selected at random from all genes in the data.

FIG. 16 illustrates a computer network or similar digital processing environment in which embodiments of the invention may be implemented.

FIG. 17 is a diagram of an example internal structure of a computer in the computer system of FIG. 16.

### DETAILED DESCRIPTION OF THE INVENTION

### Definitions

By “alteration” is meant a change (increase or decrease) in the expression levels or activity of a gene or polypeptide as detected by standard art known methods such as those described herein. As used herein, an alteration includes a 10% change in expression levels, such as a 25% change, a 40% change, or a 50% or greater change in expression levels.

By “analyte” is meant a substance that is the subject of an analytical method. Exemplary analytes include proteins, polynucleotides (e.g., RNA, DNA, methylated DNA, and other modified polynucleotides), metabolites, carbohydrate, and lipids.

By “biologic sample” is meant any tissue, cell, fluid, or other material derived from an organism.

By “case subject” is meant a subject identified as having a disease.

By “control subject” is meant a healthy subject that does not have the disease.

In this disclosure, “comprises,” “comprising,” “containing” and “having” and the like can have the meaning ascribed to them in U.S. Patent law and can mean “includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

“Detect” refers to identifying the presence, absence or amount of the object to be detected.

A “detectable” expression level, as used herein, means a level that is detectable by standard techniques currently known in the art or those that become standard at some future time, and include for example, differential display, RT (reverse transcriptase)-coupled polymerase chain reaction (PCR), Northern Blot, and/or RNase protection analyses. The degree of differences in expression levels need only be large enough to be visualized or measured via standard characterization techniques.

By “differential expression” is meant that expression is altered relative to a reference. In one embodiment, the alteration is significant when evaluated using a statistical method. In one embodiment, the alteration is increased or decreased relative to a threshold.

By “disease” is meant any condition or disorder that damages or interferes with the normal function of a cell, tissue, or organ. Examples of diseases include asthma, Parkinson's Disease, or Huntington's Disease.

By “disease state” is meant the presence, absence, or extent of disease in a subject.

By “disease module” is meant a pool of genes whose differential expression is associated with a disease.

By “disease profile” is meant a set of alterations in the level of an analyte that is associated with a disease state.

The term “expression” refers to the biosynthesis of a gene product. For example, in the case of a structural gene, expression involves transcription of the structural gene into mRNA and the translation of mRNA into one or more polypeptides.

In general, a “gene” is a region on the genome that is capable of being transcribed to an RNA that either has a regulatory function, a catalytic function, and/or encodes a protein. An eukaryotic gene typically has introns and exons, which may organize to produce different RNA splice variants that encode alternative versions of a mature protein.

By “nucleic acid molecule” is meant an oligomer or polymer of ribonucleic acid or deoxyribonucleic acid, or analog thereof.

By “polypeptide” is meant any chain of amino acids, regardless of length or post-translational modification (for example, glycosylation or phosphorylation).

By “reference” is meant a standard or control condition.

By “subject” is meant a mammal, including, but not limited to, a human or non-human mammal, such as a bovine, equine, canine, ovine, rodent, or feline.

By “marker” is meant any protein, polynucleotide or fragment thereof having an alteration in expression level or activity that is associated with a disease or disorder.

A description of example embodiments of the invention follows.

Gene expression data are routinely used to identify genes that on average exhibit different expression levels between a case and a control group. Yet, very few of such differentially expressed genes are detectably perturbed in individual patients. The disclosed methods and systems provide a framework to construct personalized perturbation profiles for individual subjects, identifying the set of genes that are significantly perturbed in each individual. This allows an analysis of the heterogeneity of the molecular manifestations of complex diseases by quantifying the expression-level similarities and differences among patients with the same phenotype. Despite the high heterogeneity of the individual perturbation profiles, patients with asthma, Parkinson's, and Huntington's disease, for example, share a broad pool of sporadically disease-associated genes. Individuals with considerable overlap with this pool have a 85%-100% chance of being diagnosed with the disease. The developed framework opens up the possibility to apply gene expression data in the context of precision medicine, with important implications for biomarker identification and diagnosis.

The disclosed methods and systems involve the identification of genes or proteins whose expression levels are perturbed in a single subject compared to a group of control subjects. The resulting personalized expression perturbation profiles (PEEPs) allow for a detailed investigation of the molecular roots of a disease state of a single subject, in contrast to conventional differential expression analysis methods that only yield average changes between two groups of subjects. The PEEPs can serve as a starting point to address various important challenges of personalized medicine, such as molecular-based diagnosis. The genes and/or proteins may be referred to herein as markers or biomarkers. Unlike conventional methods of differential expression analysis, which only allow for the identification of average changes between two groups, the disclosed methods and systems allow for a systematic quantification of the heterogeneity of disease states between different subjects on a molecular (e.g., gene or protein expression) level. The novel molecular signatures (disease modules) do not rely on a small set of marker genes, but on a larger set of genes that, by design, takes into account the heterogeneity of diseases.

Successful practice of the invention can be achieved with one or a combination of methods that can detect and/or quantify markers. These methods include, without limitation, sequencing methods (e.g., Sanger, Next Generation Sequencing, RNA-SEQ), hybridization-based methods, including those employed in biochip arrays, mass spectrometry (e.g., laser desorption/ionization mass spectrometry), fluorescence (e.g., sandwich immunoassay), surface plasmon resonance, ellipsometry and atomic force microscopy. Expression levels of markers (e.g., polynucleotides, polypeptides, or other analytes) are compared by procedures well known in the art, such as RT-PCR, Northern blotting, Western blotting, flow cytometry, immunocytochemistry, binding to magnetic and/or antibody-coated beads, in situ hybridization, fluorescence in situ hybridization (FISH), flow chamber adhesion assay, ELISA, microarray analysis, or colorimetric assays. Methods may further include one or more of electrospray ionization mass spectrometry (ESI-MS), ESI-MS/MS, ESI-MS/(MS)ⁿ, matrix-assisted laser desorption ionization time-of-flight mass spectrometry (MALDI-TOF-MS), surface-enhanced laser desorption/ionization time-of-flight mass spectrometry (SELDI-TOF-MS), desorption/ionization on silicon (DIOS), secondary ion mass spectrometry (SIMS), quadrupole time-of-flight (Q-TOF), atmospheric pressure chemical ionization mass spectrometry (APCI-MS), APCI-MS/MS, APCI-(MS)ⁿ, atmospheric pressure photoionization mass spectrometry (APPI-MS), APPI-MS/MS, and APPI-(MS), quadrupole mass spectrometry, fourier transform mass spectrometry (FTMS), and ion trap mass spectrometry, where n is an integer greater than zero.

Detection methods may include use of a biochip array. Biochip arrays useful in the invention include protein and polynucleotide arrays. One or more markers are captured on the biochip array and subjected to analysis to detect the level of the markers in a sample.

Markers may be captured with capture reagents that are immobilized to a solid support, such as a biochip, a multiwell microtiter plate, a resin, or a nitrocellulose membrane that is subsequently probed for the presence or level of a marker. Capture can be on a chromatographic surface or a biospecific surface. For example, a sample containing a protein marker may be used to contact the active surface of a biochip for a sufficient time to allow binding to a capture molecule. Unbound molecules are washed from the surface using a suitable eluant, such as phosphate buffered saline. In general, the more stringent the eluant, the more tightly the markers must be bound to be retained after the wash.

Upon capture on a biochip, a marker can be detected by a variety of detection methods selected from, for example, a gas phase ion spectrometry method, an optical method, an electrochemical method, atomic force microscopy and a radio frequency method. In one embodiment, mass spectrometry, and in particular, SELDI, is used. Optical methods include, for example, detection of fluorescence, luminescence, chemiluminescence, absorbance, reflectance, transmittance, birefringence or refractive index (e.g., surface plasmon resonance, ellipsometry, a resonant mirror method, a grating coupler waveguide method or interferometry). Optical methods include microscopy (both confocal and non-confocal), imaging methods and non-imaging methods. Immunoassays in various formats (e.g., ELISA) are popular methods for detection of analytes captured on a solid phase. Electrochemical methods include voltametry and amperometry methods. Radio frequency methods include multipolar resonance spectroscopy.

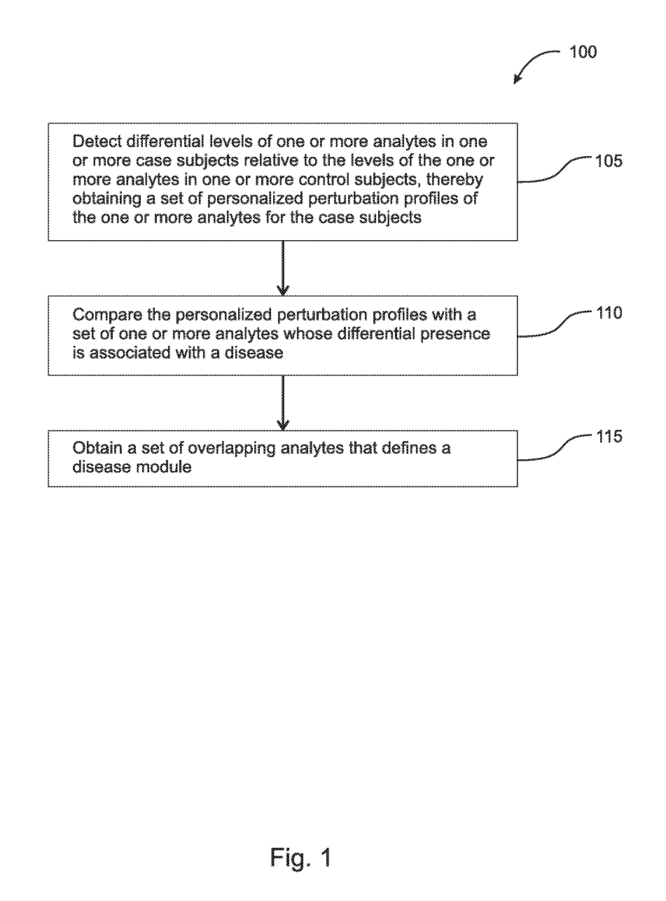

FIG. 1 is a flow chart illustrating generating a disease module, according to an example embodiment of the present invention. The illustrated embodiment is a computer-implemented method 100 of generating a disease module, the method comprising: a. detecting (105) differential levels of one or more analytes in one or more case subjects relative to the levels of the one or more analytes in one or more control subjects, thereby obtaining a set of personalized perturbation profiles of the one or more analytes for the case subjects; b. comparing (110) the personalized perturbation profiles with a set of one or more analytes whose differential presence is associated with said disease; and c. obtaining (115) a set of overlapping analytes that defines the disease module.

As used herein, the term “overlapping” refers to analytes that are present, and analytes that are absent (i.e. having a deviation above, or below the calculated mean level of the analyte, respectively) in the perturbation profiles of all case subjects. As used herein, the term “partially overlapping” refers to analytes that are present, and analytes that are absent (i.e. having a deviation above, or below the calculated mean level of the analyte, respectively) in the perturbation profiles of a portion of the case subjects. As used herein, the term “non-overlapping” refers to analytes that are present, and analytes that are absent (i.e. having a deviation above, or below the calculated mean level of the analyte, respectively) in the perturbation profiles of a one case subject.

In some embodiments, detecting differential levels of one or more analytes in one or more case subjects relative to the levels of the one or more analytes in one or more control subjects, thereby obtaining a set of personalized perturbation profiles of the one or more analytes for the case subjects comprises: a. calculating a mean level of each analyte detected in the one or more control subjects; b. calculating, using the calculated mean level each analyte detected in the one or more control subjects, the deviation of the level of each analyte detected in the one or more test subjects; and c. identifying, in the one or more test subjects, analytes with a deviation above or below a threshold deviation level from the calculated mean.

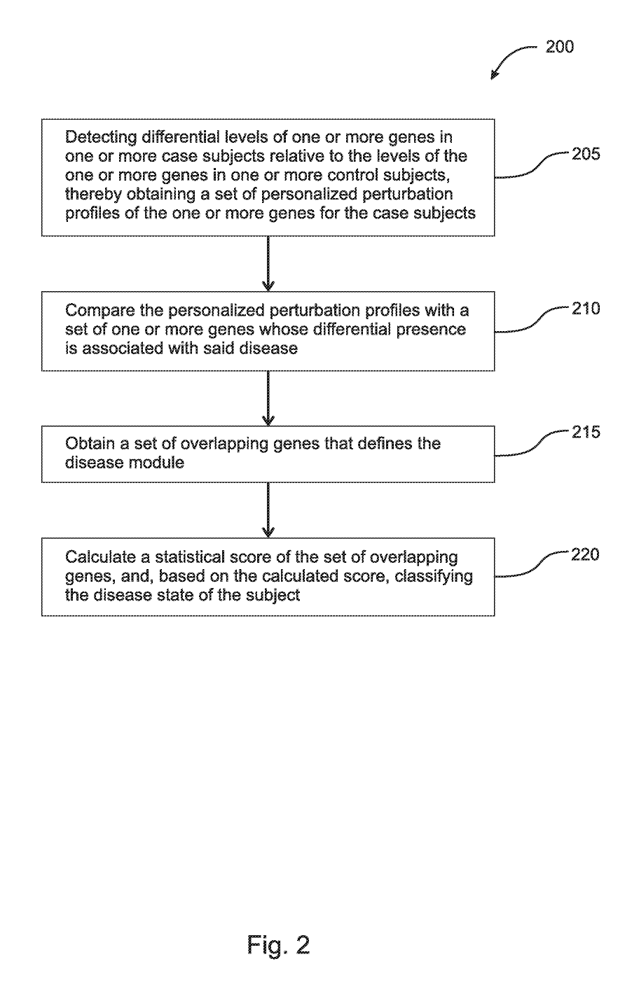

FIG. 2 is a flow chart illustrating classifying the disease state of a subject, according to an example embodiment of the present invention. The illustrated embodiment is a computer-implemented method 200 of classifying the disease state of a subject, the method comprising: a. detecting (205) differential levels of one or more genes in one or more case subjects relative to the levels of the one or more genes in one or more control subjects, thereby obtaining a set of personalized perturbation profiles of the one or more genes for the case subjects; b. comparing (210) the personalized perturbation profiles with a set of one or more genes whose differential presence is associated with said disease; c. obtaining (215) a set of overlapping genes that defines the disease module; and d. calculating (220) a statistical score of the set of overlapping genes, and, based on the calculated score, classifying the disease state of the subject.

In some embodiments, detecting differential levels of one or more genes in one or more case subjects relative to the levels of the one or more genes in one or more control subjects, thereby obtaining a set of personalized perturbation profiles of the one or more genes for the case subjects comprises: a. calculating a mean level of each gene detected in the one or more control subjects; b. calculating, using the calculated mean level each gene detected in the one or more control subjects, the deviation of the level of each gene detected in the one or more test subjects; c. identifying, in the one or more test subjects, genes with a deviation above or below a threshold deviation level from the calculated mean.

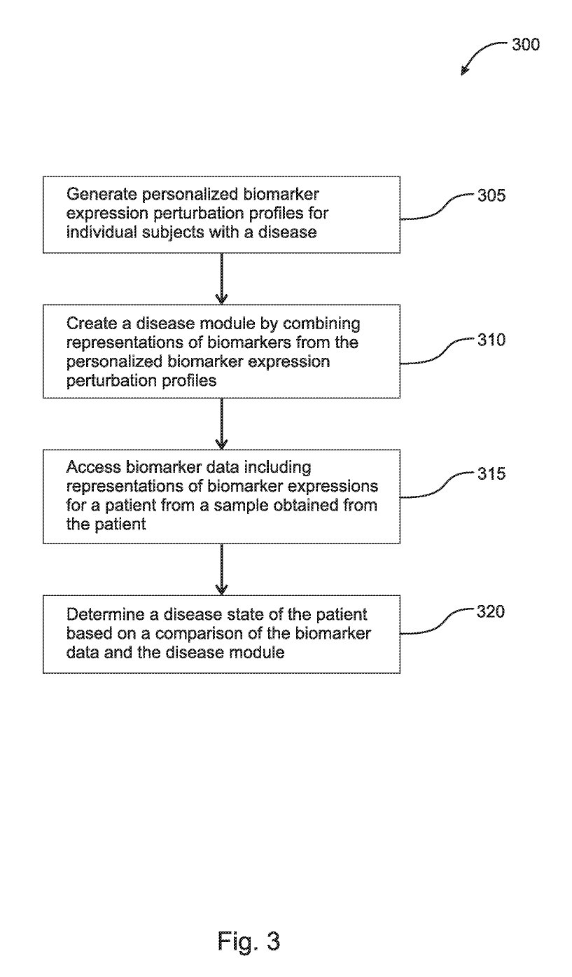

Referring to FIG. 3d, in some embodiments, the deviation is measured by the z-score:

$${z}_{i}^{j} = \frac{{l}_{i}^{j} - {〈 {l}_{i} 〉}_{cont}}{{σ}_{cont} ( {l}_{i} )} ,$$

Where, for each gene i of subject j the expression level lᵢ^{j} is compared to the reference distribution of expression levels of that gene within the control group. The z-score captures how many standard deviations σ_{cont}(lᵢ) the individual expression level lᵢ^{j} deviates from the mean value [symbol] lᵢ [symbol] _{cont} of the control group.

In some embodiments, the threshold deviation level is a global threshold zₜₕᵣₑₛₕ that identifies the genes that are sufficiently perturbed in an individual subject.

In some embodiments, the resulting individual perturbation expression profile (PEEP) of a subject can be viewed as a “barcode,” representing the genes that are up- (zᵢ^{j}>zₜₕᵣₑₛₕ) or down-regulated (zᵢ^{j}<zₜₕᵣₑₛₕ) compared to the control group.

In some embodiments, zₜₕᵣₑₛₕ is from 1.5 to 4. In some embodiments, is zₜₕᵣₑₛₕ 2.5.

In some embodiments, the present invention is a computer-implemented method of generating a disease module, the method comprising: a. detecting differential expression of a plurality of genes in an individual case subject relative to the expression levels of the plurality genes in at least one control subject, thereby obtaining a personalized perturbation profile for the subject; b. compiling the personalized perturbation profile from the individual subject across a population of case subjects; c. comparing the compiled personalized perturbation profiles with a set of genes whose differential expression is associated with said disease; and d. obtaining a set of overlapping genes from the compiled perturbation profiles that defines the disease module.

In some embodiments, detecting differential expression of a plurality of genes in an individual case subject relative to the expression levels of the plurality genes in at least one control subject, thereby obtaining a personalized perturbation profile for the subject comprises: a. calculating a mean level of each gene detected in the at least one control subject; b. calculating, using the calculated mean level each gene detected in the at least one control subject, the deviation of the level of each gene detected in the test subjects; c. identifying, in the test subjects, genes with a deviation above or below a threshold deviation level from the calculated mean.

In some embodiments, the method further comprises obtaining a set of partially overlapping genes and non-overlapping genes from the compiled perturbation profiles. In some embodiments, the method further comprises calculating, based on the overlapping genes, partially overlapping genes, and non-overlapping genes, an expression heterogeneity of the disease.

In some embodiments, the expression heterogeneity of the disease is calculated by determining the mean pair-wise similarity of the data of the individuals in the case and control groups.

In some embodiments, the mean pair-wise similarity is determined by the distribution of Jaccard indicies

$$J = \frac{\vert A ⋂ B \vert}{\vert A ⋃ B \vert}$$

for all pairwise gene sets A and B of the individuals in the case and control groups.

In some embodiments, the statistical score is determined using the Fisher's exact test.

In some embodiments, the present invention provides a specifically programmed computer system comprising:

a. at least one specialized computer machine comprising:
i. a non-transient memory, electronically storing particular computer executable program code; and
ii. at least one computer processor which, when executing the particular program code, becomes a specifically programmed computer processor configured to perform at least the following operations:
   a. detecting differential levels of one or more analytes in one or more case subjects relative to the levels of the one or more analytes in one or more control subjects, thereby obtaining a set of personalized perturbation profiles of the one or more analytes for the case subjects;
   b. comparing the personalized perturbation profiles with a set of one or more analytes whose differential presence is associated with said disease; and
   c. obtaining a set of overlapping analytes that defines the disease module.

In some embodiments, detecting differential levels of one or more genes in one or more case subjects relative to the levels of the one or more genes in one or more control subjects, thereby obtaining a set of personalized perturbation profiles of the one or more genes for the case subjects comprises: a. calculating a mean level of each analyte detected in the one or more control subjects; b. calculating, using the calculated mean level each analyte detected in the one or more control subjects, the deviation of the level of each analyte detected in the one or more test subjects; c. identifying, in the one or more test subjects, analytes with a deviation above or below a threshold deviation level from the calculated mean.

In some embodiments, the present invention provides a specifically programmed computer system comprising:

a. at least one specialized computer machine comprising:
i. a non-transient memory, electronically storing particular computer executable program code; and
ii. at least one computer processor which, when executing the particular program code, becomes a specifically programmed computer processor configured to perform at least the following operations:
   a. detecting differential levels of one or more genes in one or more case subjects relative to the levels of the one or more genes in one or more control subjects, thereby obtaining a set of personalized perturbation profiles of the one or more genes for the case subjects;
   b. comparing the personalized perturbation profiles with a set of one or more genes whose differential presence is associated with said disease;
   c. obtaining a set of overlapping genes that defines the disease module; and
   d. calculating a statistical score of the set of overlapping genes, and, based on the calculated score, classifying the disease state of the subject.

In some embodiments, detecting differential levels of one or more genes in one or more case subjects relative to the levels of the one or more genes in one or more control subjects, thereby obtaining a set of personalized perturbation profiles of the one or more genes for the case subjects comprises: a. calculating a mean level of each gene detected in the one or more control subjects; b. calculating, using the calculated mean level each gene detected in the one or more control subjects, the deviation of the level of each gene detected in the one or more test subjects; and c. identifying, in the one or more test subjects, genes with a deviation above or below a threshold deviation level from the calculated mean.

In some embodiments, the present invention provides a specifically programmed computer system comprising: a. detecting differential expression of a plurality of genes in an individual case subject relative to the expression levels of the plurality genes in at least one control subject, thereby obtaining a personalized perturbation profile for the subject; b. compiling the personalized perturbation profile from the individual subject across a population of case subjects; c. comparing the compiled personalized perturbation profiles with a set of genes whose differential expression is associated with said disease; and d. obtaining a set of overlapping genes from the compiled perturbation profiles that defines the disease module.

In some embodiments, detecting differential expression of a plurality of genes in an individual case subject relative to the expression levels of the plurality genes in at least one control subject, thereby obtaining a personalized perturbation profile for the subject comprises: a. calculating a mean level of each gene detected in the at least one control subject; b. calculating, using the calculated mean level each gene detected in the at least one control subject, the deviation of the level of each gene detected in the test subjects; c. identifying, in the test subjects, genes with a deviation above or below a threshold deviation level from the calculated mean.

In some embodiments, the method further comprises obtaining a set of partially overlapping genes and non-overlapping genes from the compiled perturbation profiles. In some embodiments, the method further comprises calculating, based on the overlapping genes, partially overlapping genes, and non-overlapping genes, an expression heterogeneity of the disease.

FIG. 3 is a flow chart illustrating determining a disease state of a patient, according to an example embodiment of the present invention. The illustrated method 300 includes generating (305) personalized biomarker expression perturbation profiles for a plurality of individual subjects with a disease. The personalized biomarker expression perturbation profiles include representations of biomarkers that are perturbed beyond a threshold amount. The biomarker expression levels are associated with gene expression levels, and in some embodiments may be protein expression levels. The method further includes creating (310) a disease module by combining representations of biomarkers from the personalized biomarker expression perturbation profiles. The disease module includes a network of representations of biomarkers having perturbations associated with the disease. The method further includes accessing (315) biomarker data including representations of biomarker expressions for the patient from a sample obtained from the patient, and determining (320) the disease state of the patient based on a comparison of the biomarker data and the disease module.

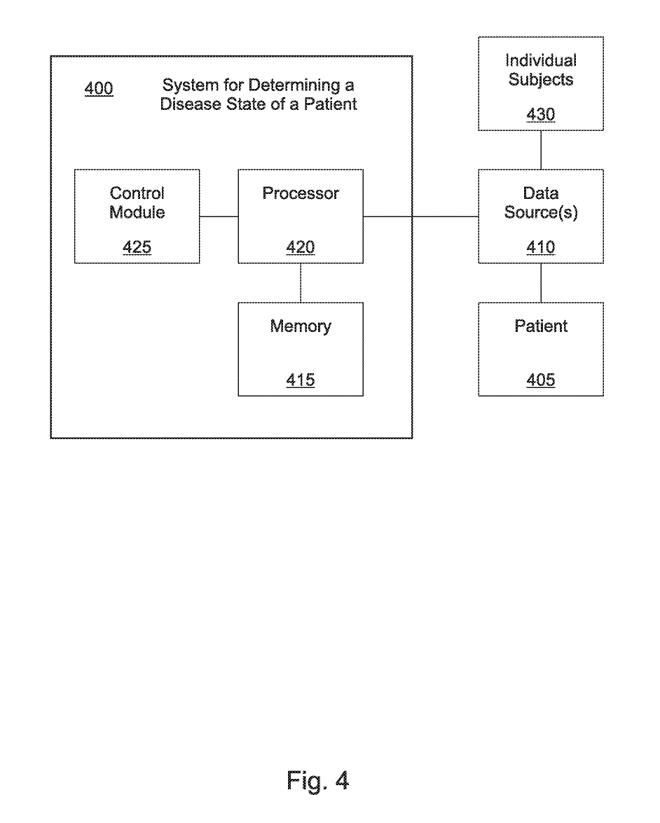

FIG. 4 is a block diagram illustrating a system 400 for determining a disease state of a patient 405, according to an example embodiment of the present invention. The system 400 includes memory 415, a data source 410, a hardware processor 420 in communication with the memory 415 and the data source 410, and a control module 425 in communication with the processor 420. The hardware processor 420 is configured to perform a predefined set of operations in response to receiving a corresponding instruction selected from a predefined native instruction set of codes. The control module 425 includes a first set of machine codes selected from the native instruction set for causing the hardware processor 420 to obtain from the data source 410 and store in the memory 415 representations of biomarker expressions for a plurality of individual subjects 430 with a disease. The biomarker expression levels are associated with gene expression levels, and in some embodiments may be protein expression levels. The control module 425 further includes a second set of machine codes for causing the hardware processor 420 to generate and store in the memory 415 personalized biomarker expression perturbation profiles for the plurality of individual subjects 430. The personalized biomarker expression perturbation profiles include representations of biomarkers that are perturbed beyond a threshold amount. The control module 425 further includes a third set of machine codes for causing the hardware processor 420 to create and store in the memory 415 a disease module by combining representations of biomarkers from the personalized biomarker expression perturbation profiles. The disease module includes a network of representations of biomarkers having perturbations associated with the disease. The control module 425 further includes a fourth set of machine codes for causing the hardware processor 420 to access from the data source 410 biomarker data including representations of biomarker expressions for the patient from a sample obtained from the patient 405. The control module 425 further includes a fifth set of machine codes for causing the hardware processor 420 to determine the disease state of the patient 405 based on a comparison of the biomarker data and the disease module.

The following is a detailed explanation of concepts behind the disclosed methods and systems with specific examples.

The practice of many embodiments of the present invention employs, unless otherwise indicated, conventional techniques of molecular biology (including recombinant techniques), microbiology, cell biology, biochemistry and immunology, which are well within the purview of the skilled artisan. Such techniques are explained fully in the literature, such as, “Molecular Cloning: A Laboratory Manual”, second edition (Sambrook, 1989); “Oligonucleotide Synthesis” (Gait, 1984); “Animal Cell Culture” (Freshney, 1987); “Methods in Enzymology” “Handbook of Experimental Immunology” (Weir, 1996); “Gene Transfer Vectors for Mammalian Cells” (Miller and Calos, 1987); “Current Protocols in Molecular Biology” (Ausubel, 1987); “PCR: The Polymerase Chain Reaction”, (Mullis, 1994); “Current Protocols in Immunology” (Coligan, 1991). These techniques are applicable to the production of the polynucleotides and polypeptides of embodiments of the invention, and, as such, may be considered in making and practicing embodiments of the invention. Particularly useful techniques for particular embodiments will be discussed in the sections that follow.

The following examples are put forth so as to provide those of ordinary skill in the art with a complete disclosure and description of how to make and use the assay, screening, and therapeutic methods of the methods and system disclosed herein, and are not intended to limit the scope of what the inventors regard as their invention.

### INTRODUCTION

Microarray techniques, and more recently RNA sequencing, have fundamentally changed our ability to explore the molecular mechanisms underlying complex diseases, being routinely used to identify disease-associated genome-wide changes in gene expression patterns. An important goal of these studies is the identification of differentially expressed (DE) genes, whose expression level systematically differs between a case (disease) and a control (healthy) group. The expectation is that such DE genes will help pinpoint the molecular processes perturbed in a disease, which in turn can be used as biomarkers for diagnosis and prognosis (see Showe, M. K. et al. Gene expression profiles in peripheral blood mononuclear cells can distinguish patients with non-small cell lung cancer from patients with nonmalignant lung disease. Cancer research 69, 9202-9210 (2009) and Taylor, I. W. et al. Dynamic modularity in protein interaction networks predicts breast cancer outcome. Nature Biot. 27, 199-204 (2009)), patient classification and drug target identification. For example differential expression patterns of whole blood cells have long been considered promising candidates for cheap, easily accessible biomarkers for multiple diseases (see Zeller, T. & Blankenberg, S. Blood-based gene expression tests: promises and limitations. Circulation. Cardiovascular genetics 6, 139-140 (2013)).

Despite their extraordinary use in research and medicine, the interpretation and validation of gene expression patterns continues to offer major challenges. Indeed, results from similar studies are often inconsistent, the proposed biomarkers are often not reproduced, and the identified DE genes rarely point to a unique set of disease-associated genes (see Ein-Dor, L., Kela, I., Getz, G., Givol, D. & Domany, E. Outcome signature genes in breast cancer: is there a unique set? Bioinformatics 21 (2004)). For example, a meta study of multiple heart failure studies failed to identify any gene that is differentially expressed in all seven datasets, the most reproduced gene being differentially expressed only in four datasets (see Asakura, M. & Kitakaze, M. Global gene expression profiling in the failing myocardium. Circ. J. 73, 1568-1576 (2009)). Two main reasons are often listed as the source for these inconsistencies: (i) The comparison of different microarray-based measurement is hindered by important technical challenges, like the use of different platforms, dyes or statistical methods. (ii) There is intrinsic variability in gene expression levels, driven by both genetic factors, like the effect of single nucleotide polymorphisms (SNPs) and copy number variations (CNVs) on expression qualitative trait loci (eQTLs) (see Stranger, B. E. et al. Relative impact of nucleotide and copy number variation on gene expression phenotypes. Science 315, 848-853 (2007) and Stranger, B. E. et al. Population genomics of human gene expression. Nature Gen. (2007)), and non-genetic factors (see Spielman, R. S. et al. Common genetic variants account for differences in gene expression among ethnic groups. Nature Gen. (2007); Cheung, V. G. & Spielman, R. S. Genetics of human gene expression: mapping DNA variants that influence gene expression. Nature Rev. Gen. 10, 595-604 (2009); Wu, L. et al. Variation and genetic control of protein abundance in humans. Nature 499, 79-82 (2013); Alemu, E. Y, Carl, J. W., Bravo, H. C. & Hannenhalli, S. Determinants of expression variability. Nucleic Acids Res. (2014)), arising from epigenetic modifications (see Jaenisch, R. & Bird, A. Epigenetic regulation of gene expression: how the genome integrates intrinsic and environmental signals. Nature Gen. 33 (2003)) and the inherent stochasticity of biological processes (see Elowitz, M. B. Stochastic gene expression in a single cell. Science 297 (2002); Li, J., Min, R., Vizeacoumar, F. & Jin, K. Exploiting the determinants of stochastic gene expression in saccharomyces cerevisiae for genome-wide prediction of expression noise. Proc. Natl. Acad. Sci. U.S.A. (2010); and Balazsi, G., van Oudenaarden, A. & Collins, J. J. Cellular decision making and biological noise: from microbes to mammals. Cell 144, 910-925 (2011)). Here, we focus on a third important yet less explored factor: the heterogeneity of complex diseases, i.e., the possibility that multiple, only partially or non-overlapping molecular mechanisms can act in different patients with the same phenotype. For example, breast and colorectal tumors typically contain about 80 mutated genes (see Wood, L. D. et al. The genomic landscapes of human breast and colorectal cancers. Science 318, 1108-1113 (2007)). Yet, the mutations in different tumors have very little overlap, resulting in an astonishing number of more than 1,700 mutated genes identified in only 22 tumors. To date, about 140 “driver genes” have been identified, whose mutation promotes tumorigenesis in most cancer types, but only two to eight of these driver genes are mutated in any individual tumor (see Vogelstein, B. et al. Cancer genome landscapes. Science 339, 1546-1558 (2013)). A similar phenomenon is likely to occur at the gene expression level: many different perturbations may be associated with the same phenotype. We must therefore develop bottom-up methodologies that can interpret in a predictive fashion the inherent heterogeneity of individual perturbation profiles of both healthy and disease patients.

The disclosed methods and systems provide a framework to construct and integrate personalized perturbation profiles (PEEPs) from biomarker expression data, allowing us to systematically characterize the inherent heterogeneity of gene expression patterns. The approach is tested on asthma, a chronic inflammatory disease of the lung, Parkinson's disease (PD), a progressive disorder of the nervous system (see Scherzer, C. R. et al. Molecular markers of early Parkinson's disease based on gene expression in blood. Proc. Natl. Acad. Sci. U.S.A. 104, 955-960 (2007)), and Huntington's disease (HD), a neurodegenerative disorder caused by mutations in a single gene (HTT, Huntingtin) (see Borovecki, F. et al. Genome-wide expression profiling of human blood reveals biomarkers for Huntington's disease. Proc. Natl. Acad. Sci. U.S.A. 102, 11023-11028 (2005)). In all three diseases, there is a high heterogeneity between the PEEPs of individual patients. However, these heterogeneous patterns point to the existence of a single, highly predictive disease pool specific for each disease. Test results offer a conceptual change in the way disease-associated perturbations are interpret, in line with the emerging disease module hypothesis. Accordingly, disease-associated mutations perturb some cellular function that at the molecular level is encoded into a subnetwork of the underlying interactome. Therefore, multiple, often independent perturbations can impair the functional integrity of such a module, indicating that it is intrinsically impossible to associate a single gene or pathway to a specific pathophenotype.

Results

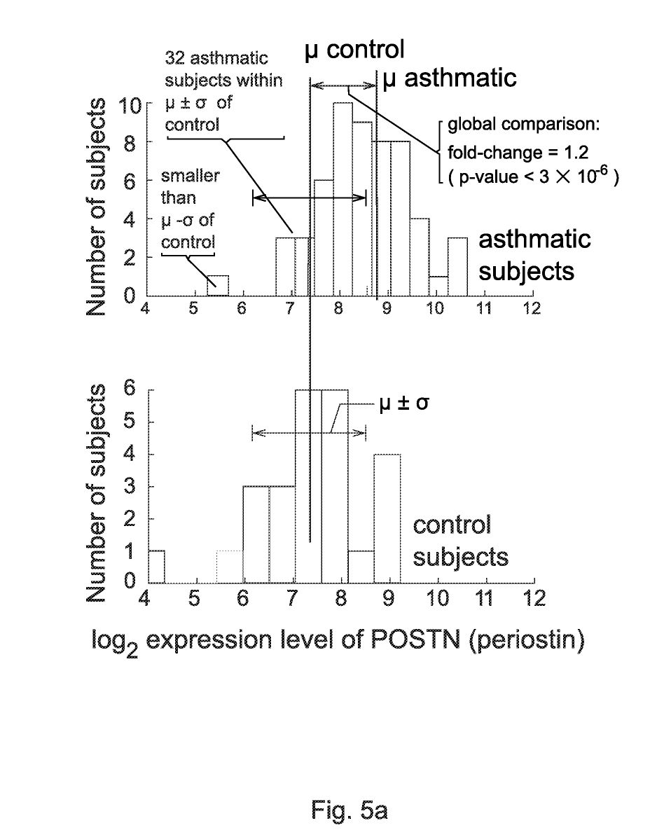

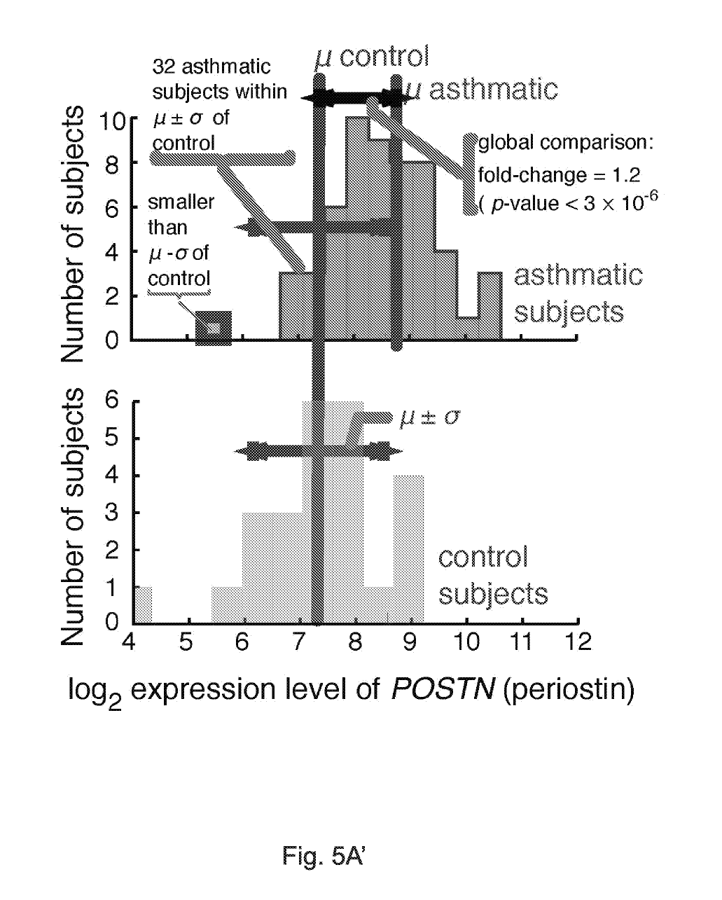

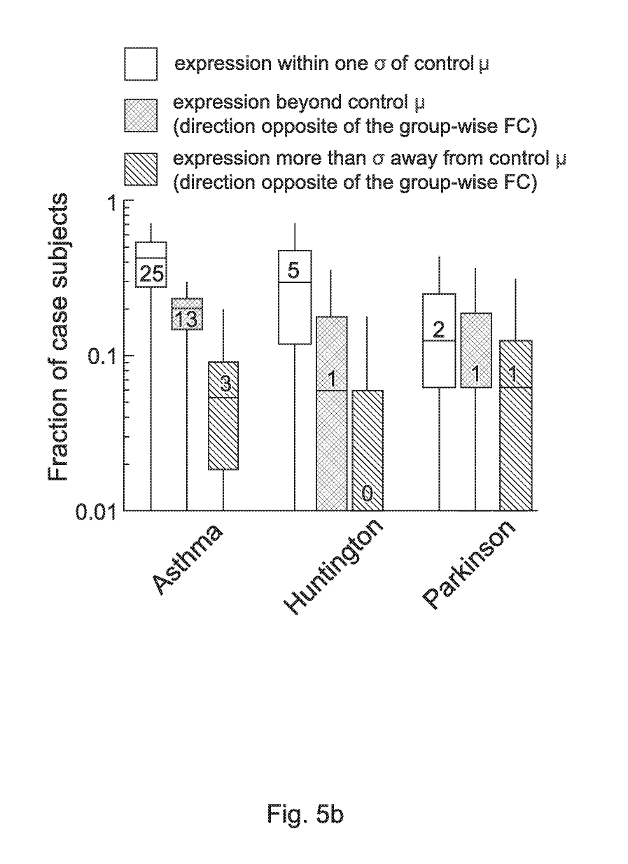

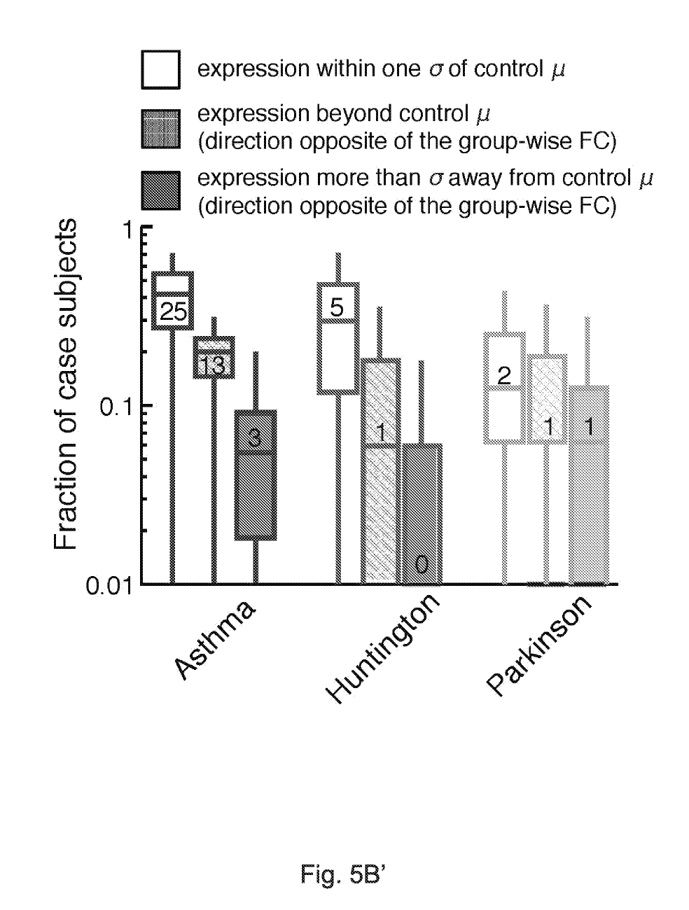

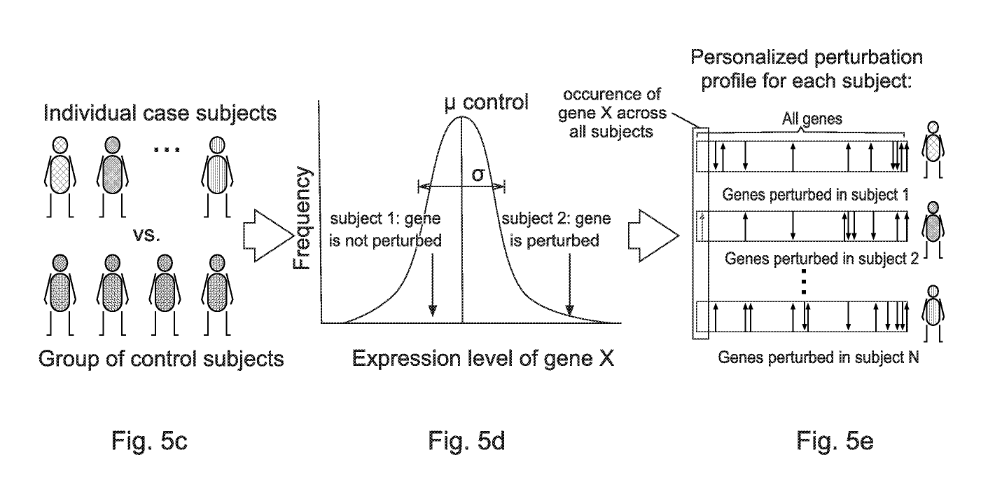

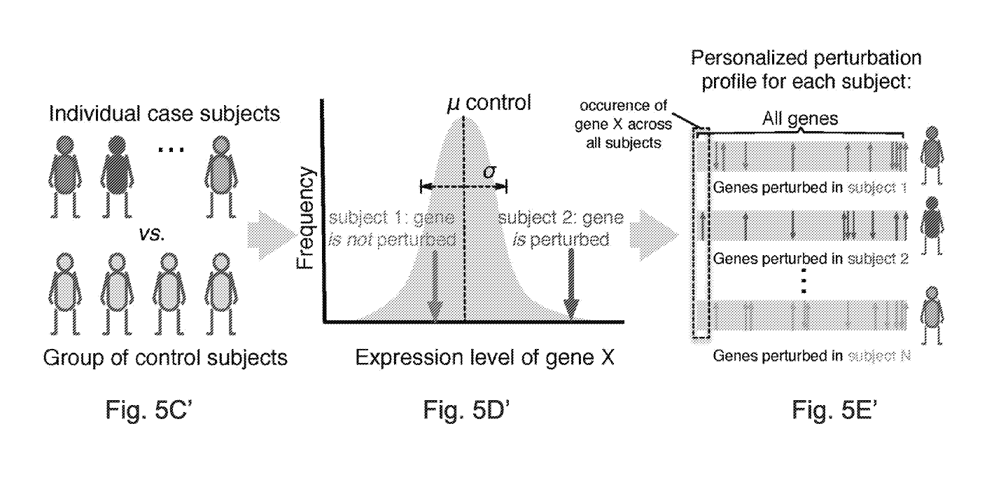

To illustrate the inherent limitations of group-based differential expression analysis, consider the POSTN gene, coding for the protein periostin. Periostin is an established biomarker for asthma (see Takayama, G. et al. Periostin: a novel component of subepithelial fibrosis of bronchial asthma downstream of IL-4 and IL-13 signals. The Journal of allergy and clinical immunology 118, 98-9104 (2006); Sidhu, S. S. et al. Roles of epithelial cell-derived periostin in TGF-activation, collagen production, and collagen gel elasticity in asthma. Proc. Natl. Acad. Sci. U.S.A. (2010); and Parulekar, A. D., Atik, M. A. & Hanania, N. A. Periostin, a novel biomarker of th2-driven asthma. Curr Opin. Pulm. Med. 20, 60-65 (2014)), its role in airway remodeling being exploited by an experimental asthma drug (see Corren, J. et al. Lebrikizumab treatment in adults with asthma. The New England Journal of Medicine (2011)). The strong differential expression pattern between asthmatic and healthy subjects confirms its asthma association (FIG. 5a, fold-change FC=1.2, p-value <3×10⁻⁶, Mann-Whitney U-test). Yet, while this group-wise difference is very pronounced, there is a more differentiated picture at the individual level: 25 out 55 asthmatic subjects have relatively low POSTN expression levels (within one standard deviation of the mean of the control group) and for 4 out of 25 control subjects the POSTN level exceeds the mean level within the asthmatic group, violating the trend identified by the group-wise analysis. Overall, for 60% of asthmatic subjects, the expression level of POSTN is within one standard deviation of the mean of the control subjects, indicating that genes that show systematic expression level differences between groups are not up- or down-regulated in each individual with the phenotype.

To generalize the above observations, we inspected the expression levels of all genes that were differentially expressed according to a standard group-wise analysis in asthma, PD and HD (see Methods, below). As shown in FIG. 5b, 13%, 30%, and 42% of all case subjects for HD, PD, and asthma, respectively, exhibit an expression level that is compatible with random expectation for control subjects (within one standard deviation a of the mean control level μ). Furthermore, 6%, 7%, and 20% of all case subjects have expression levels that were beyond the control mean in a direction that is the opposite to the one suggested by the group-wise difference. It is presumed that the effect is strongest in asthma due to the larger population sizes in the respective dataset.

A framework for personalized gene-expression analysis—These limitations can be overcome and individual expression heterogeneity can be turned into a predictive information by constructing personalized perturbation profiles that reflect expression changes within a single subject, rather than mean changes between two groups (FIG. 5c). For each gene i of subject j we compare the expression level lᵢ^{j} to the reference distribution of expression levels of that gene within the control group (FIG. 5d). The deviation is measured by the z-score

$${z}_{i}^{j} = \frac{{l}_{i}^{j} - {〈 {l}_{i} 〉}_{cont}}{{σ}_{cont} ( {l}_{i} )} ,$$

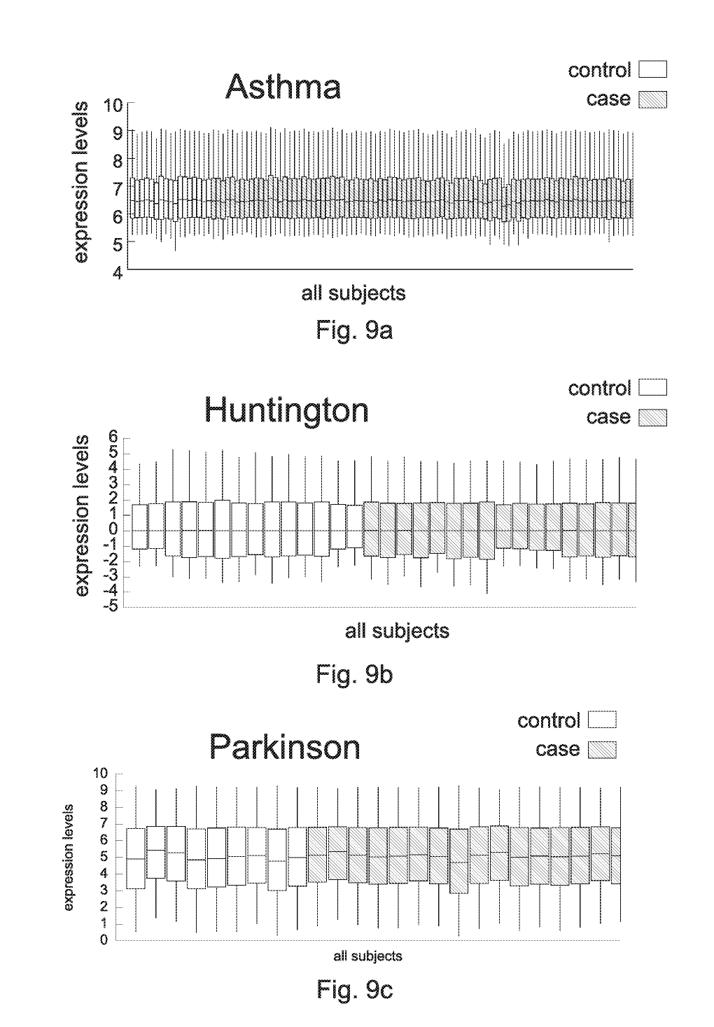

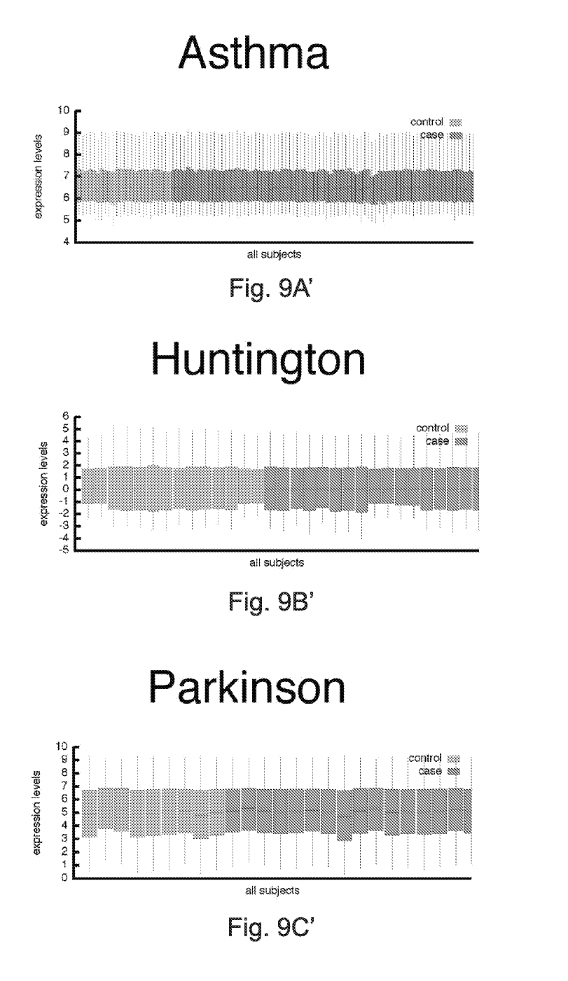

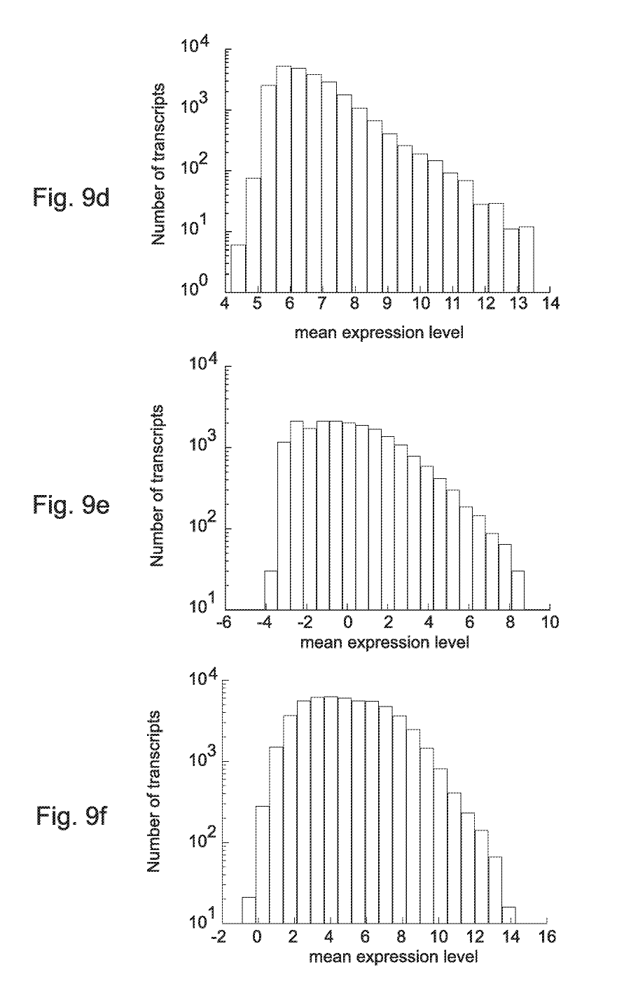

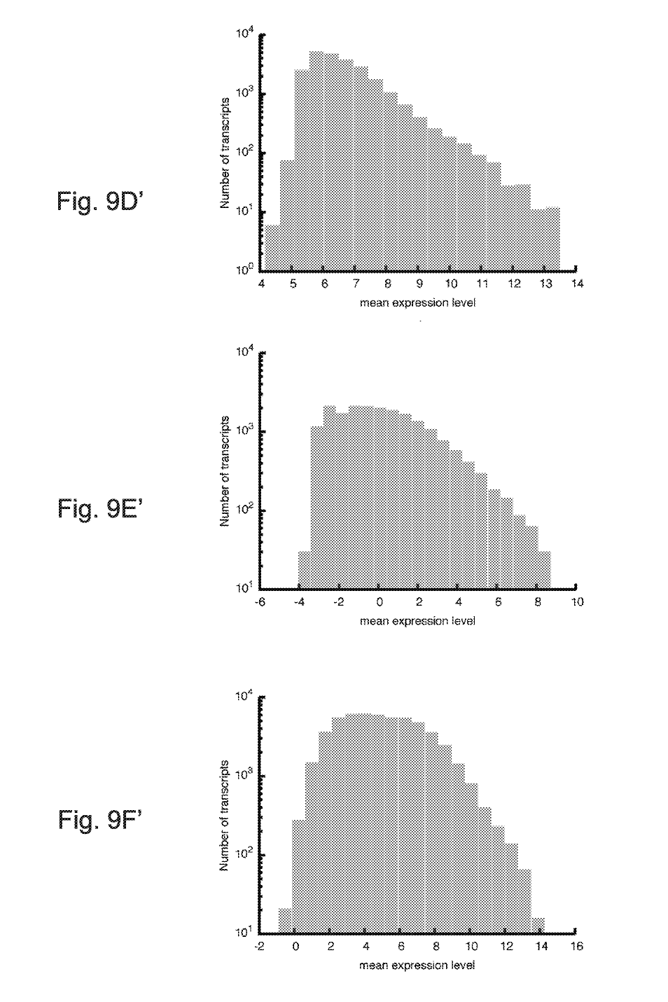

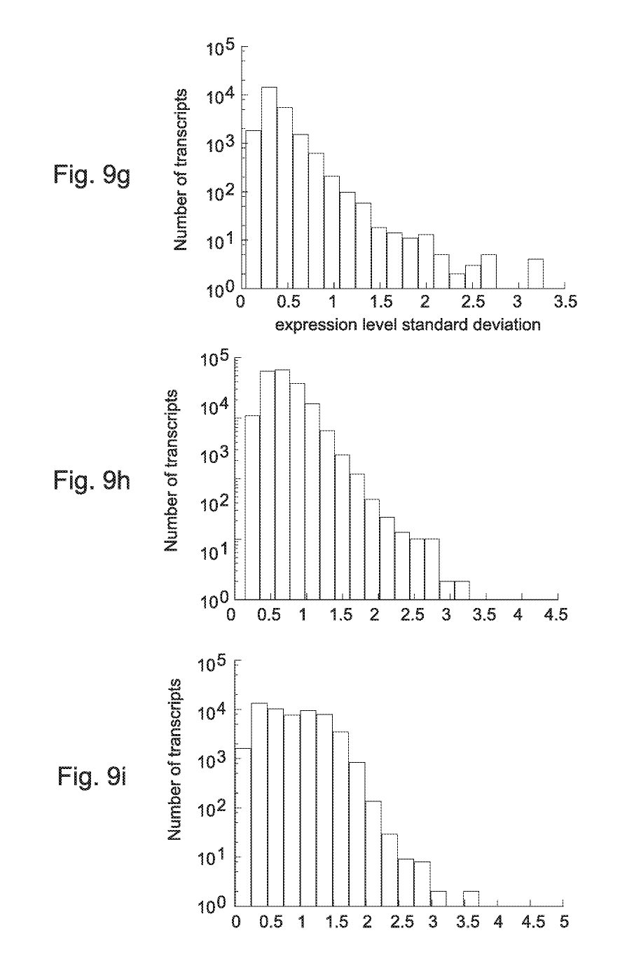

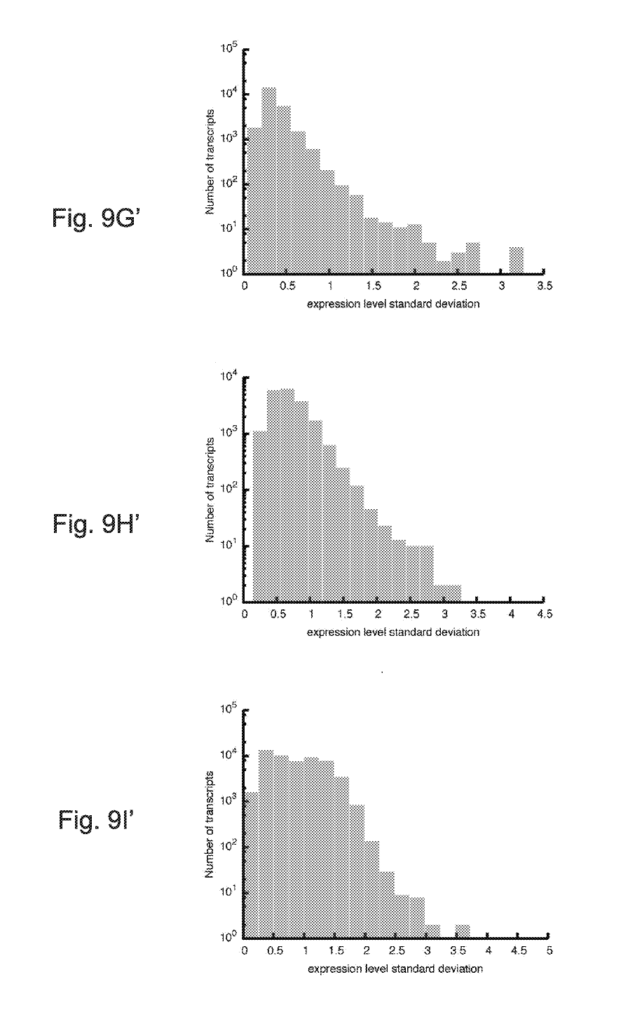

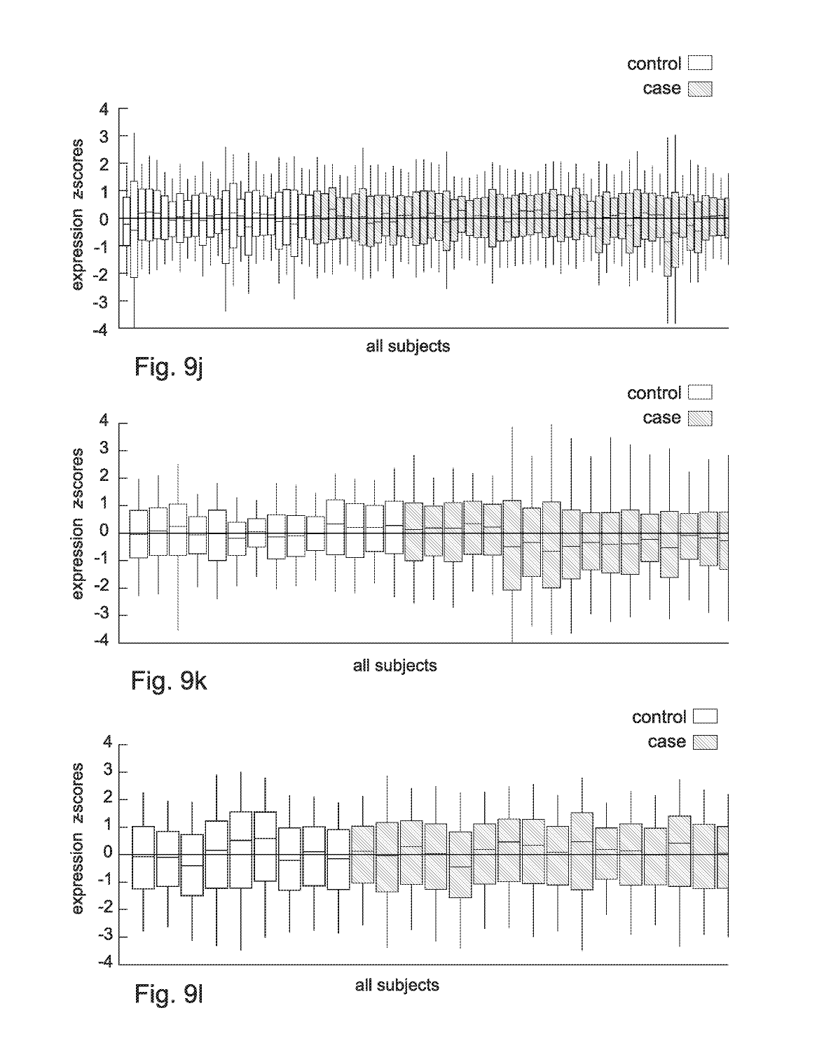

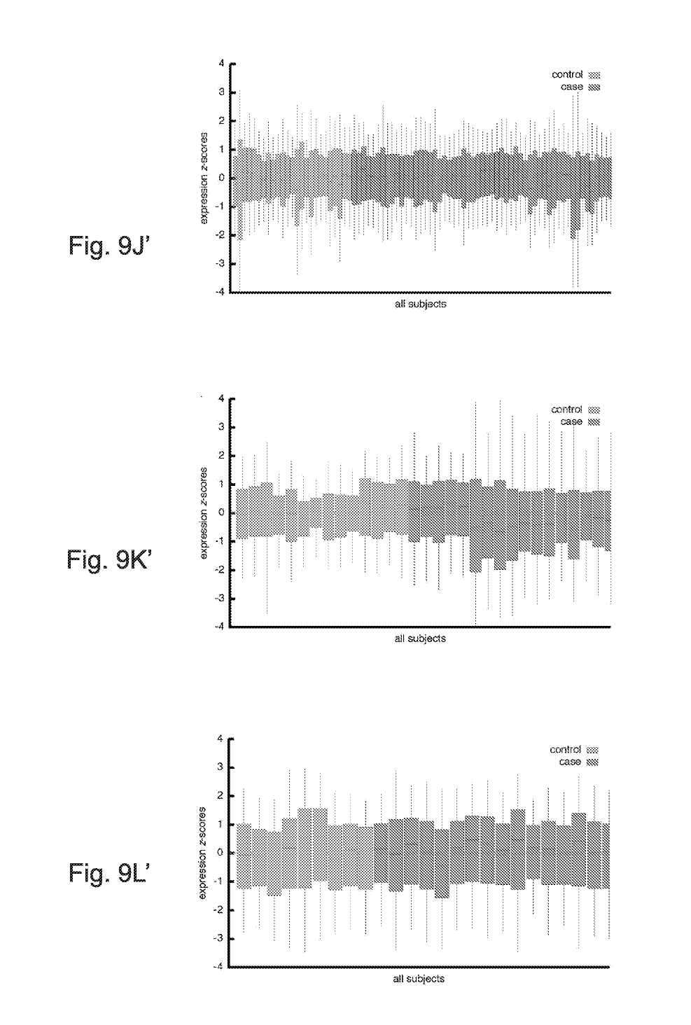

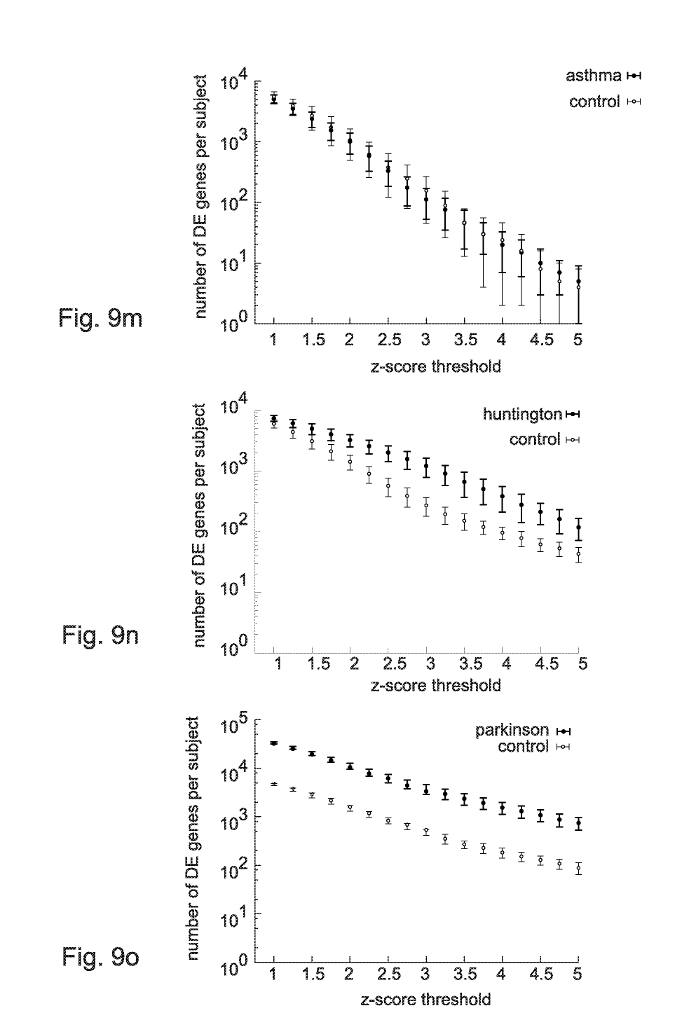

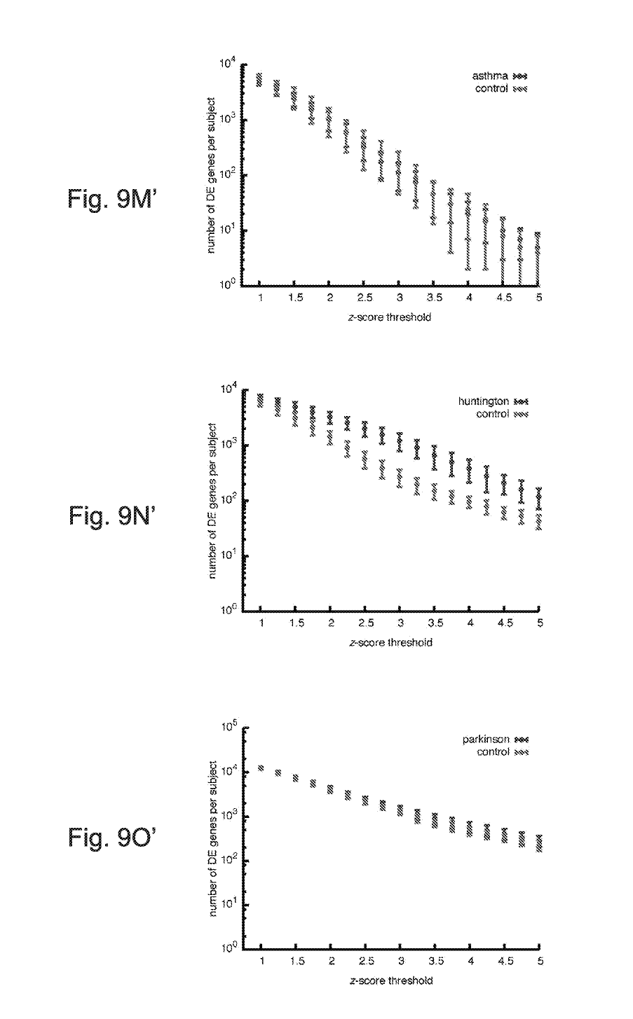

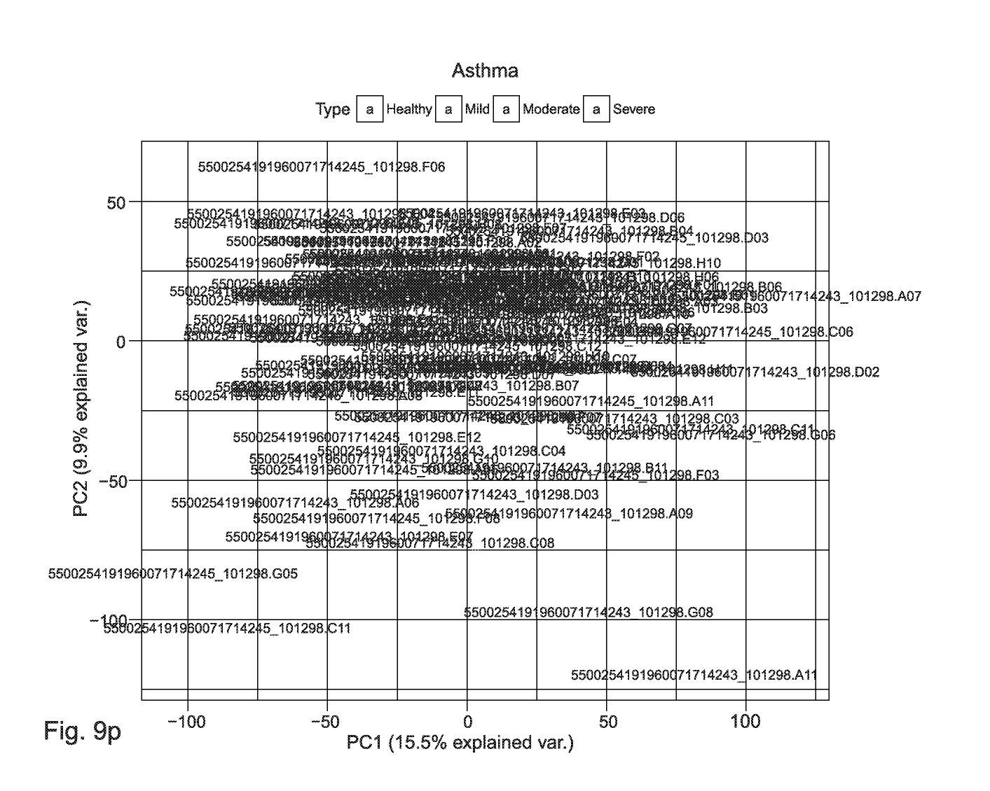

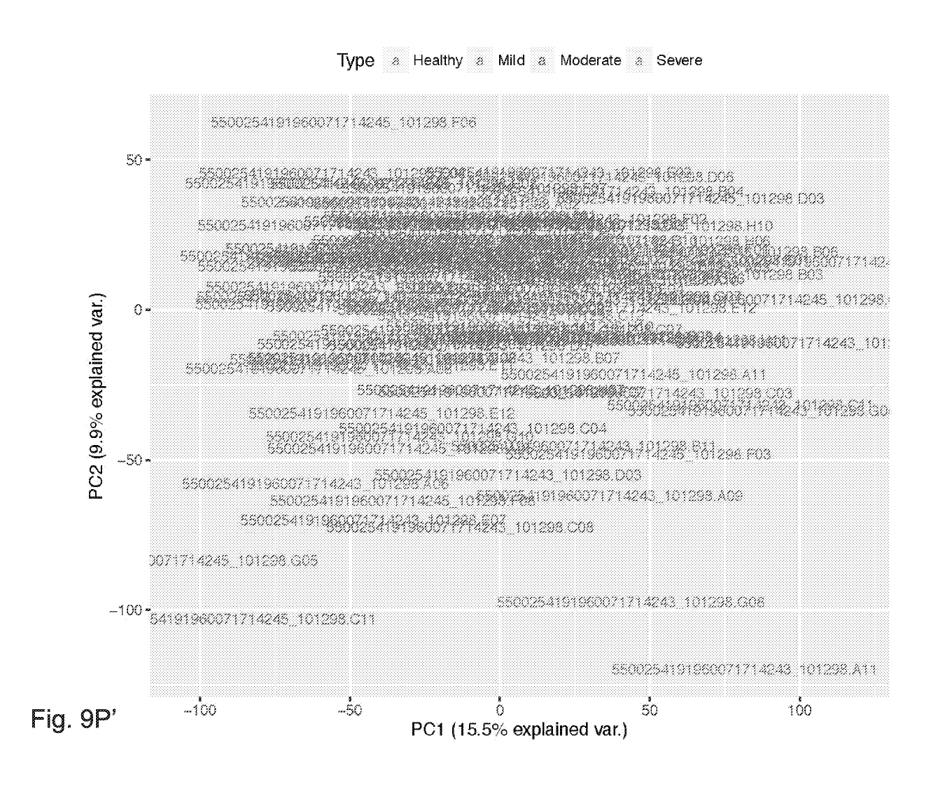

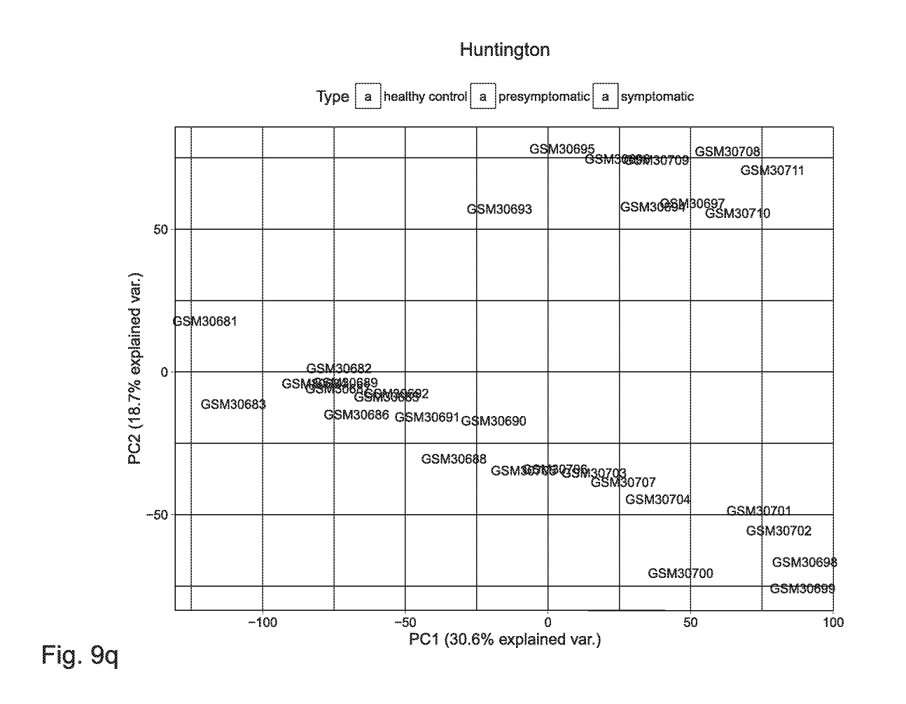

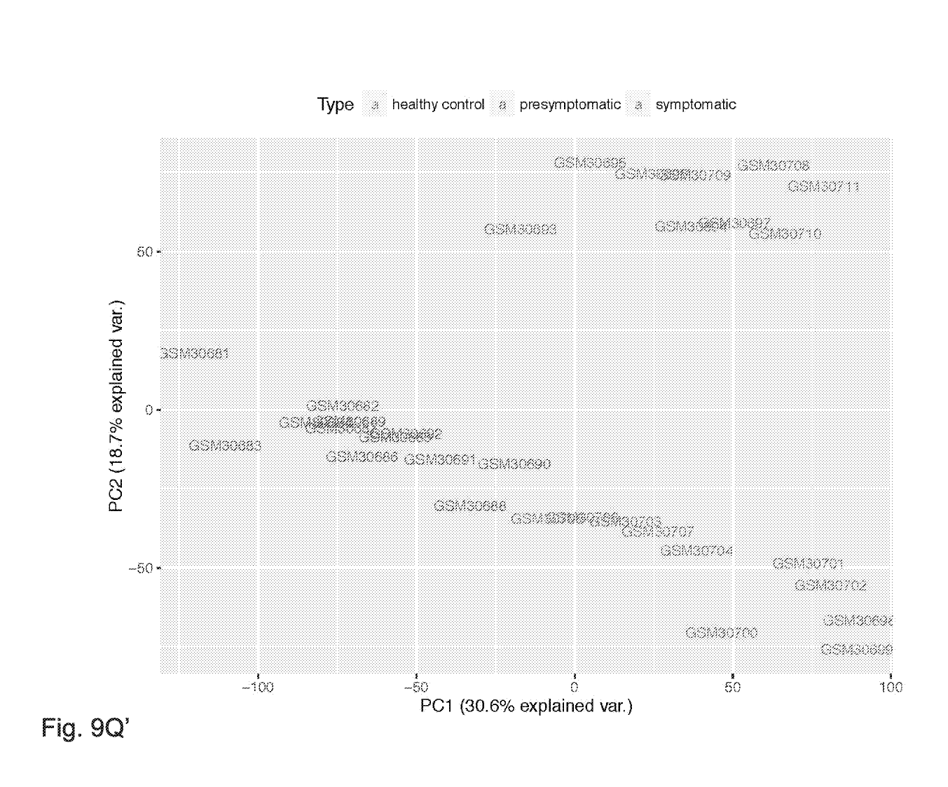

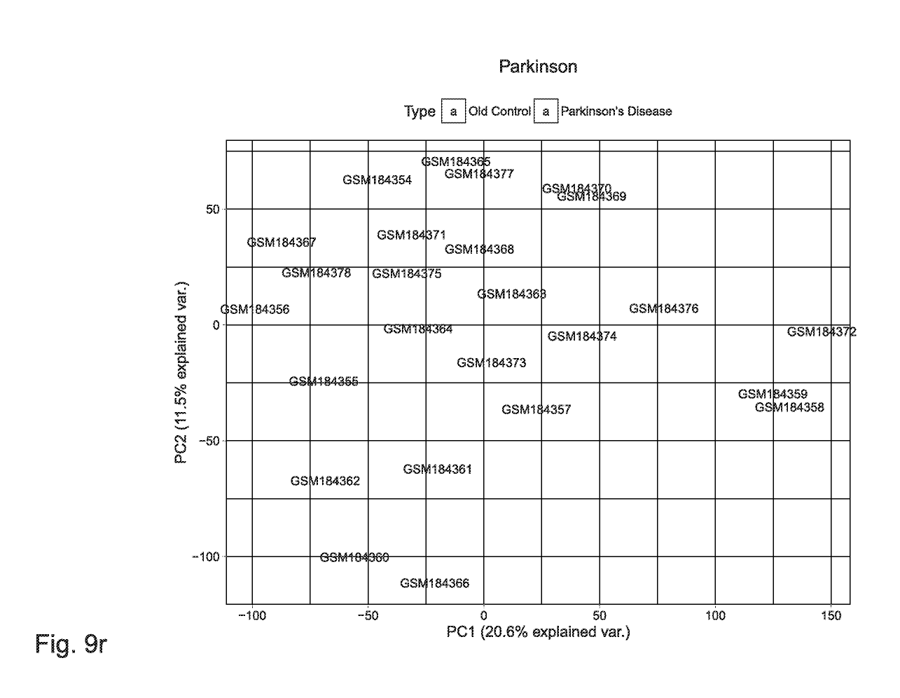

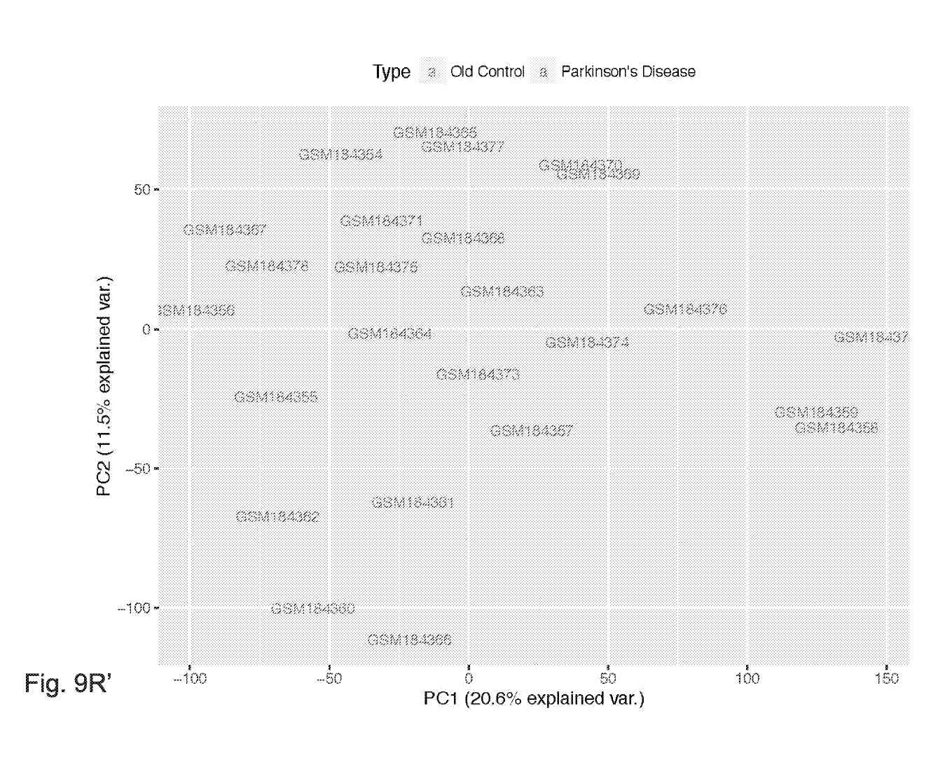

capturing how many standard deviations σ_{cont}(lᵢ) the individual expression level lᵢ^{j} deviates from the mean value [symbol] lᵢ [symbol] _{cont} of the control group. We then use a global threshold zₜₕᵣₑₛₕ to identify the genes that are sufficiently perturbed in an individual subject. The resulting individual perturbation expression profile (PEEP) of a subject can be viewed as a “barcode,” representing the genes that are up- (zᵢ^{j}>zₜₕᵣₑₛₕ) or down-regulated (zᵢ^{j}<−zₜₕᵣₑₛₕ) compared to the control group (FIG. 5e). In the following we focus on profiles obtained for zₜₕᵣₑₛₕ=2.5 (see FIG. 9 for the impact of zₜₕᵣₑₛₕ on the results).

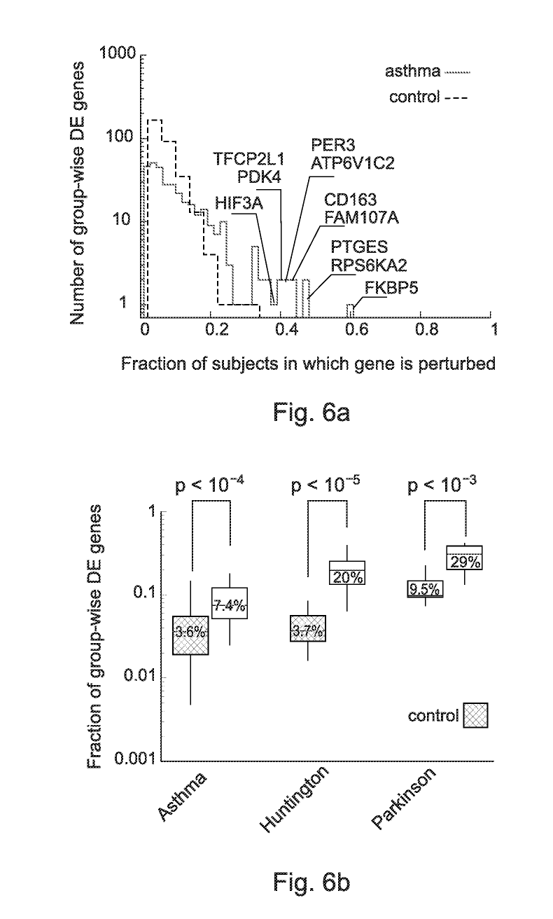

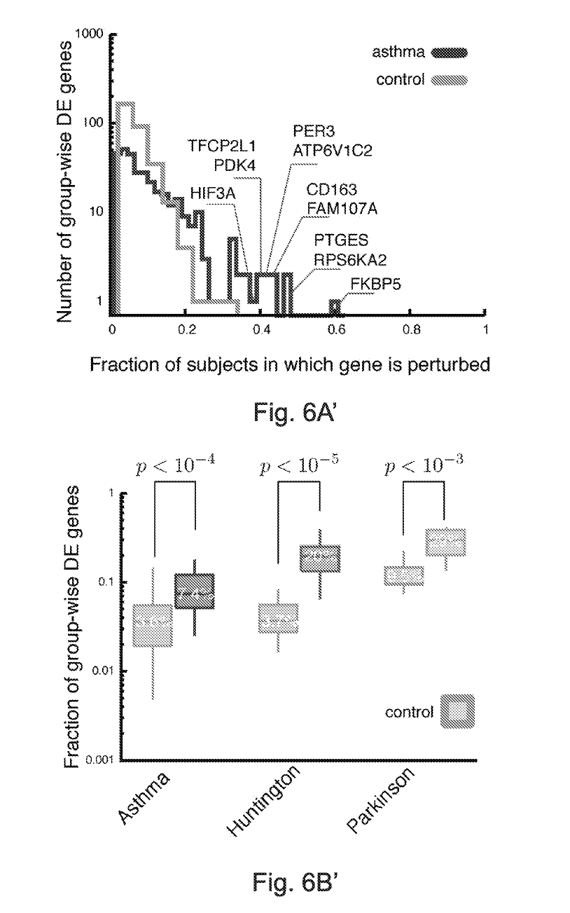

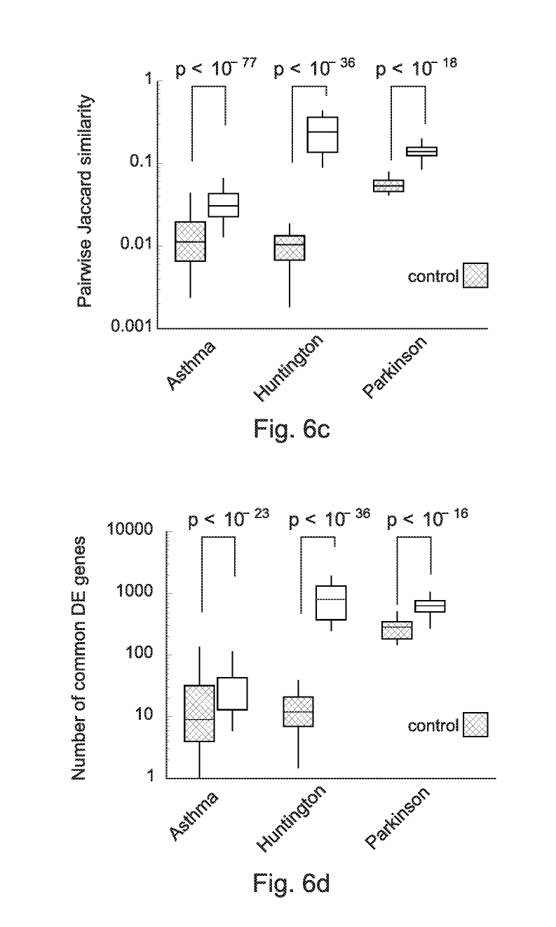

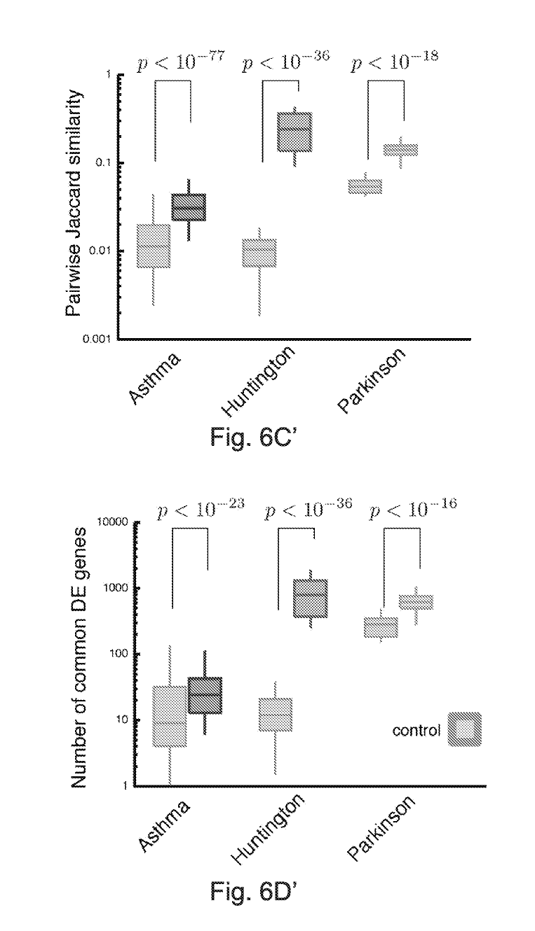

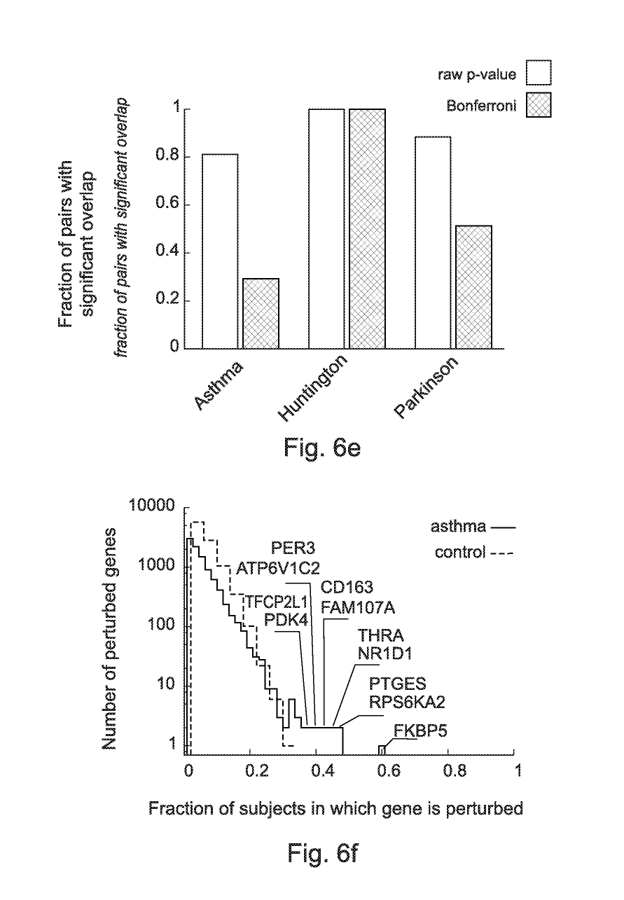

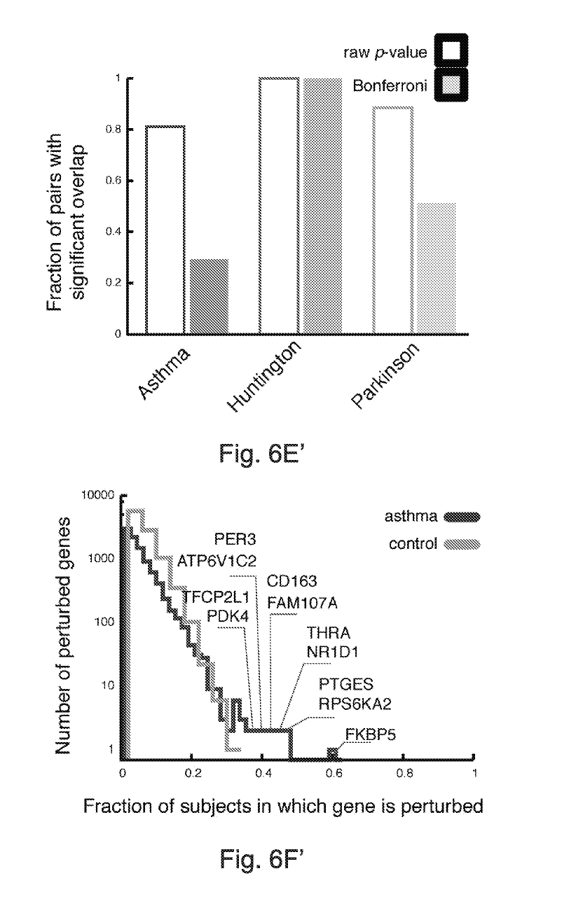

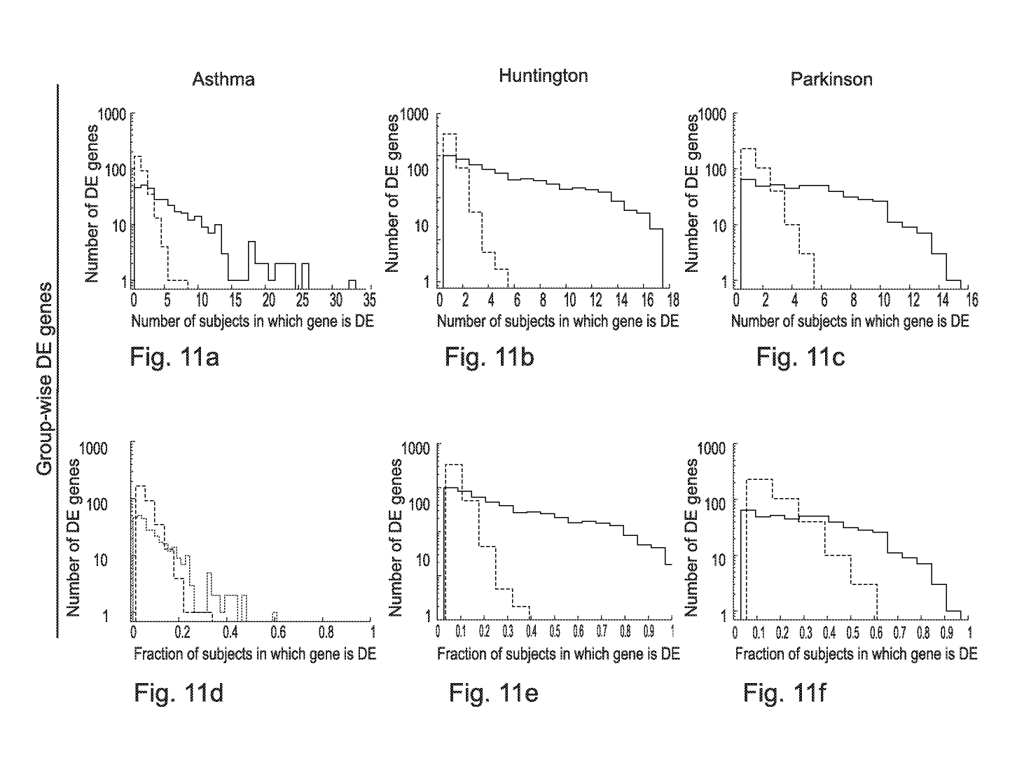

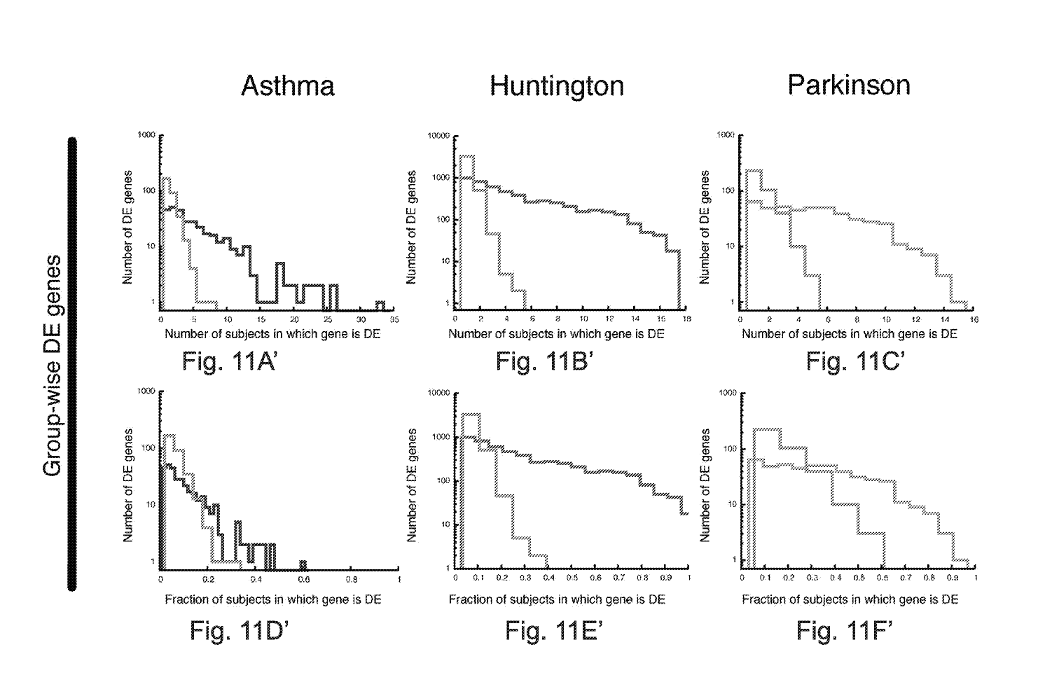

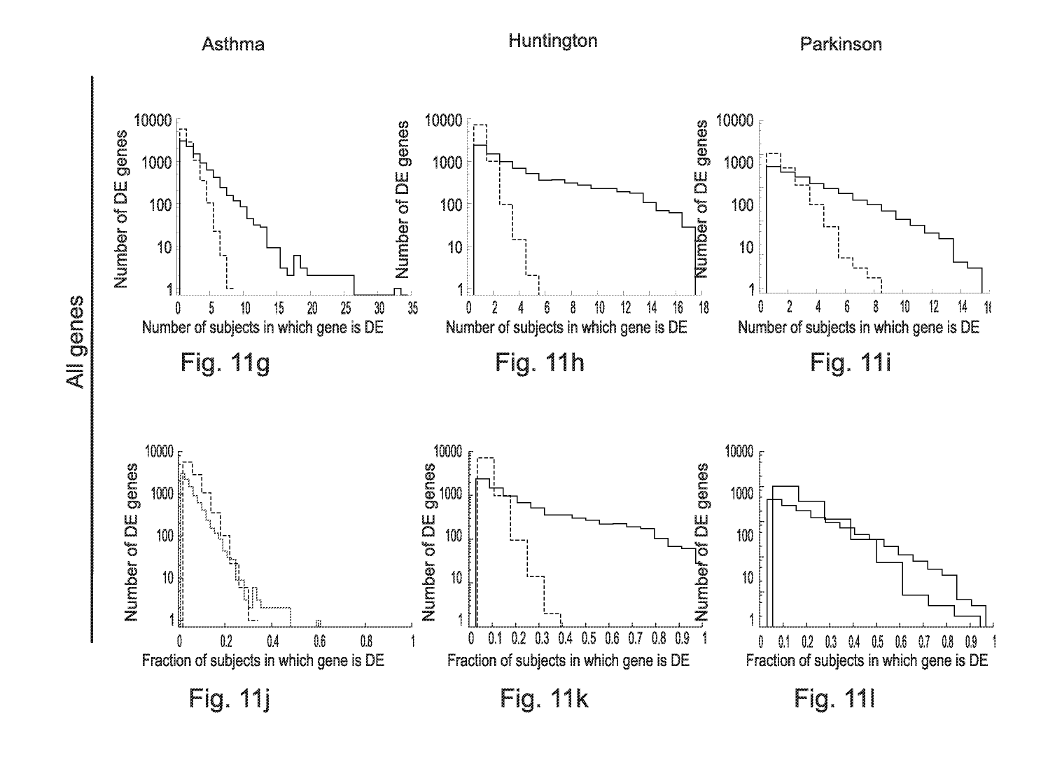

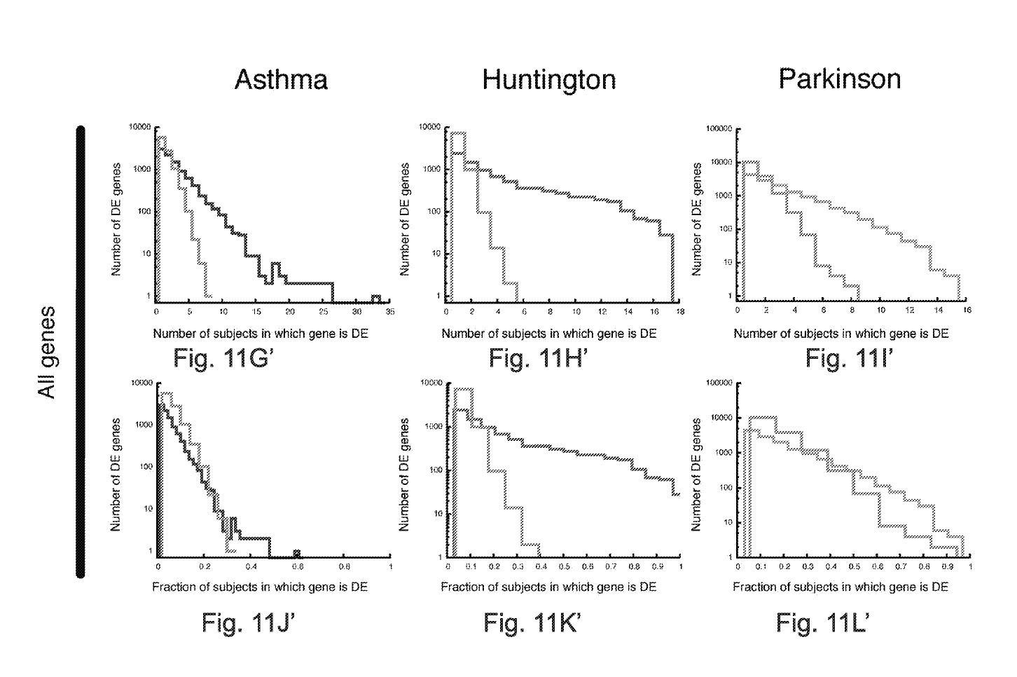

To characterize the PEEPs, the group of genes perturbed in individuals is compared with DE genes obtained from a standard group-wise approach (see Methods, below). The first observation is that only for HD we find group-wise DE genes that are contained in all individual profiles. For asthma and PD, no single gene is perturbed in all case subjects. FIG. 6a shows the distribution of the number of subjects whose personalized profile includes the same gene for asthma (see FIG. 11 for HD and PD). The maximal number of subjects sharing the group-wise DE gene FKBP5 is 33 out of 55, i.e., 60% of all asthmatic subjects. The mean number of asthmatic subjects in which a group-wise DE gene is significantly perturbed is 6 (11% of all asthmatic subjects). In PD, there is one group-wise DE gene that is shared among 15 out of 16 case subjects, in HD there are 18 genes shared among all 17 patients. On average, the group wise DE genes are contained in 31% and 29% of the case subjects for PD and HD, respectively (see also FIG. 11). FIG. 6b summarizes the fraction of the group-wise DE genes contained in the individual profiles. While this fraction is significantly higher in case subjects than in control subjects, it is still surprisingly low: For asthma, on average less than 8% of the group-wise DE genes are found in an individual profile. The highest numbers are observed for PD, where case subjects contain on average 29%. These results lead to two key main findings, on one end indicating that often DE genes identified by standard group-wise approaches are significantly perturbed only in a small fraction of individuals with the disease and likewise, any individual displays only a small fraction of all group-wise DE genes in their PEEP.

Quantifying the heterogeneity among individual perturbation profiles—To quantify the underlying expression heterogeneity of a disease, we move beyond the group-wise DE genes and ask, instead, how similar are the PEEPs of two individuals with the same disease. FIG. 6c shows the distribution of Jaccard indices

$$J = \frac{\vert A ⋂ B \vert}{\vert A ⋃ B \vert}$$

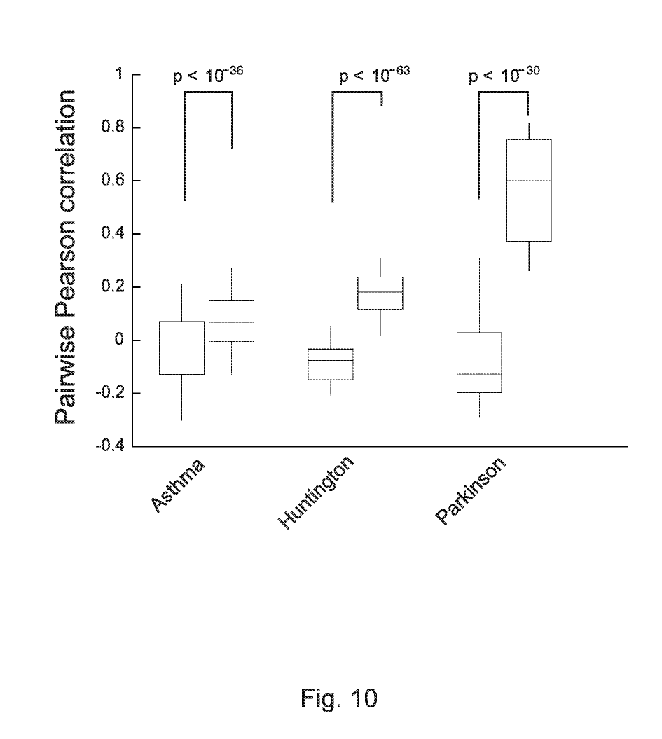

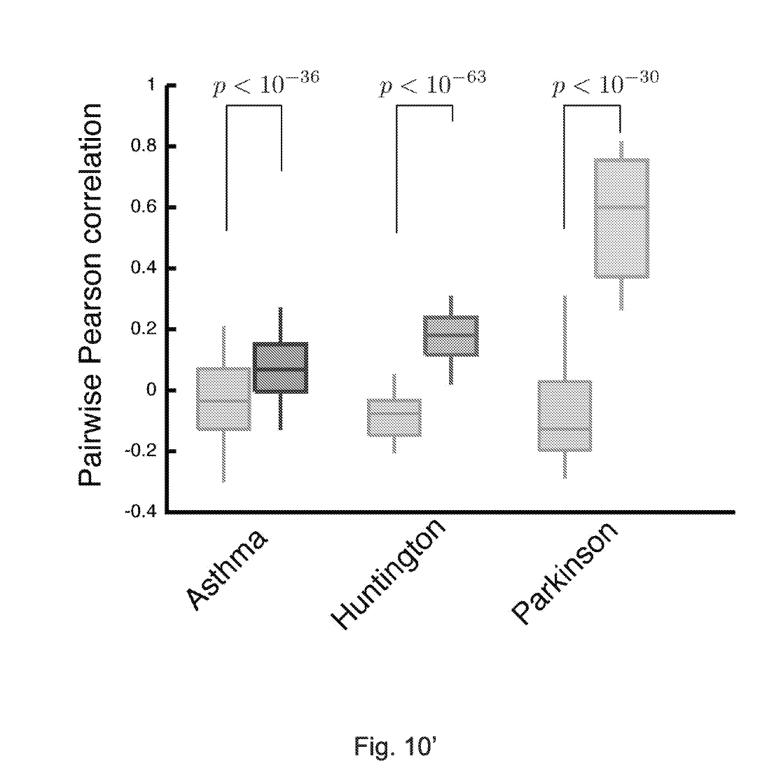

for all pairwise gene sets A and B of the individuals in the case and control groups of three diseases. For asthma, the mean pairwise similarity ( [symbol] J [symbol] =3×10⁻²) is three times higher in the case group than in the control group ( [symbol] J [symbol] =1×10⁻²). While this difference is highly significant (p-value <10⁻⁷⁷, Mann-Whitney U-test), in absolute numbers the overlap is small: While a typical asthmatic subject has on average 379 perturbed genes, the average number of shared perturbed genes between two asthmatic subjects is only 24 (FIG. 6d). For HD and PD, the average overlap between the profiles of two cases is much higher (796 and 627 common genes, respectively) due to the much higher number of genes in the individual perturbation profiles. Yet, the Jaccard similarities remain relatively small, observing [symbol] J [symbol] ˜0.24 and [symbol] J [symbol] ˜0.14 for HD and PD, respectively. The same analysis can also be performed on the full continuous z-score profiles using Pearson correlation as measure of similarity, yielding similar results (see FIG. 10).

To quantify whether the observed overlap between the PEEPs of the case subjects could have emerged by chance, we calculated the statistical significance for each pair individually using Fisher's exact test. As expected, we find the overlap to be significant for all subject pairs, even after applying the most conservative Bonferroni correction (FIG. 6e). The significant pairwise overlap documented in FIGS. 6c-e is not the result of a set of genes that are common to most subjects. Indeed, as shown in FIG. 6f for asthma, most genes within the individual profiles are perturbed only in relatively few individuals, the mean number of subjects being 3, (5% of all subjects) (see FIG. 11 for HD and PD). The most frequently perturbed gene appears in the PEEP of 33 subjects, representing 60% of the case cohort. Comparing FIG. 6a and FIG. 6f we notice that the genes appearing in many subjects' PEEPs are often also identified in the group-wise analysis, which is expected. Yet, the lack of genes present in all individual perturbation profiles again illustrates that a group-wise analysis offers only a partial picture of the expression patterns that characterize complex diseases.

This leads to our second main result: We observe highly significant similarities between the PEEPs of case subjects, similarities that are absent in healthy subjects. These similarities cannot be attributed to a few widely shared DE genes identified by the group-wise differential expression analysis, but arise from more complex patterns of pairwise overlaps.

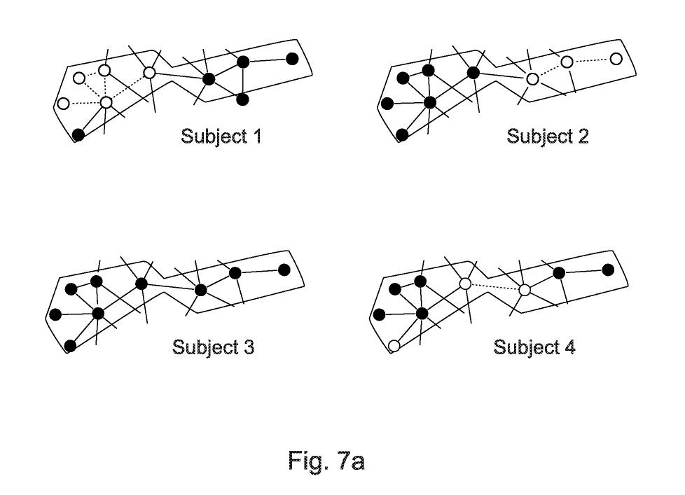

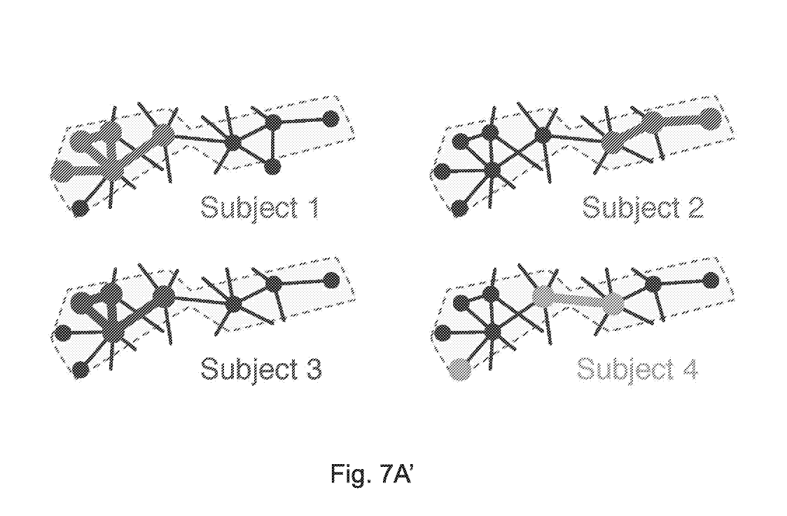

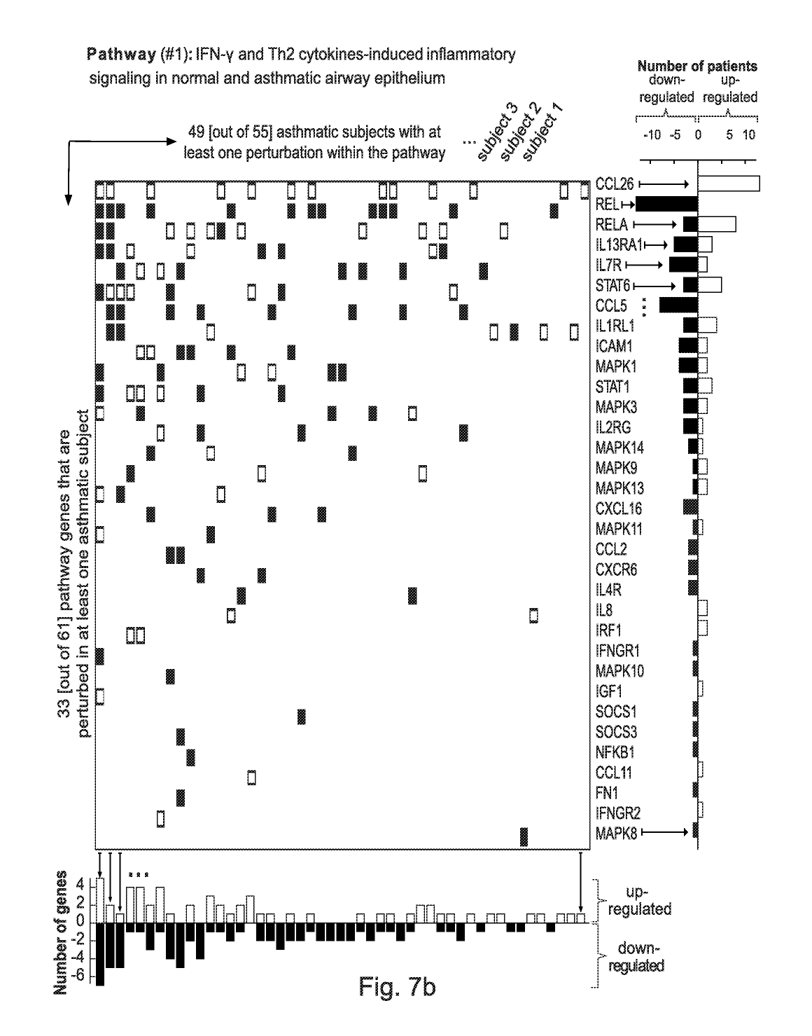

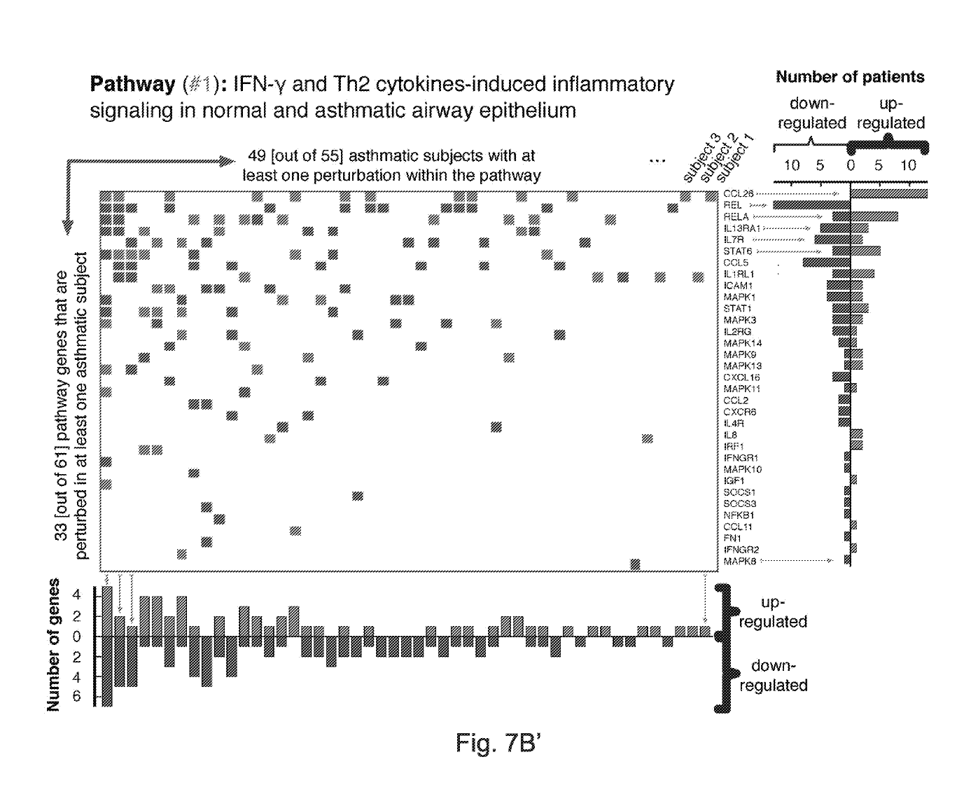

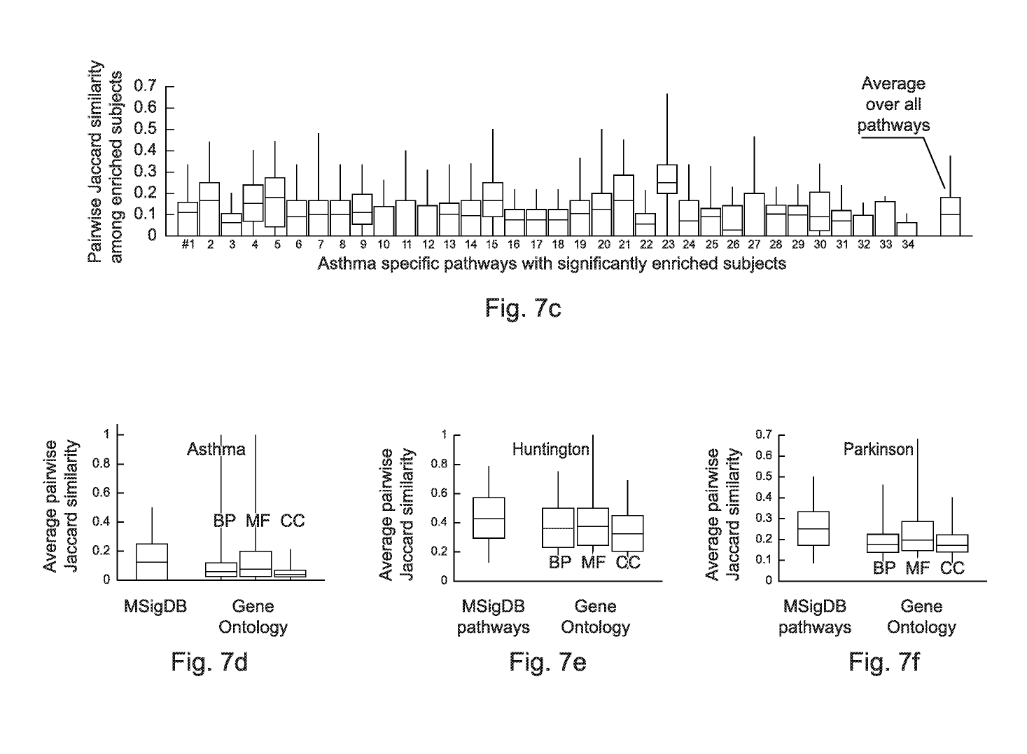

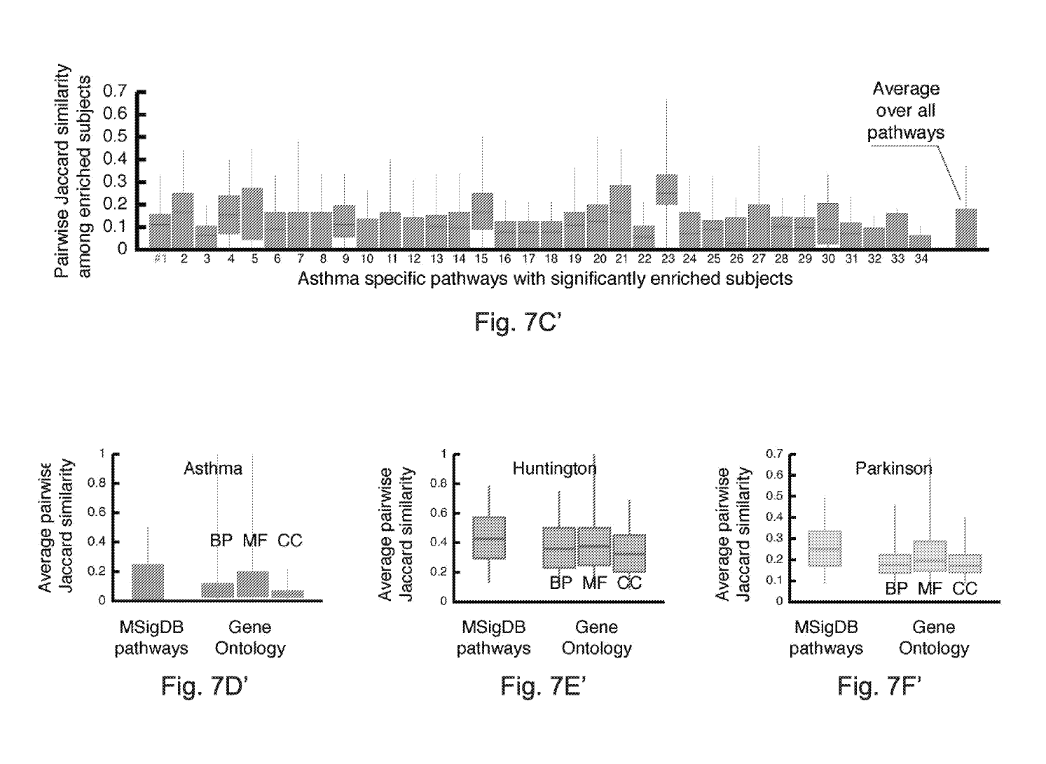

Functional analysis of the perturbation profiles—The low overlap between the personalized profiles of case subjects prompts us to ask how the molecular level heterogeneity translates into relatively homogeneous disease phenotypes. To address this, we examine the extent to which the individual profiles reflect disruptions in common disease-specific pathways (FIG. 7a). We compiled a list of 35 previously identified asthma-related pathways from GeneGo (GeneGO MetaCore from Thomson Reuters. https://portal.genego.com/) (FIG. 15) and compared the individual perturbation profiles of each asthma subject with each pathway. Almost all pathways show at least one perturbation in most subjects, and all pathways are significantly enriched in at least two individuals (Fisher's exact test, p-value <0.05, Bonferroni correction for number of pathways). Take for example the pathway IFN-γ and Th2 cytokines-induced inflammatory signaling in normal and asthmatic airway epithelium, in which 49 out of 55 asthma subjects (89%) have one or more PEEP perturbation. Yet, as FIG. 7b shows, the precise location of the perturbations within the pathway varies considerably between the individuals. In total, 33 (out of 61) genes of the pathway are up- or down-regulated in one or more patients. The genes that appear most frequently (13 subjects) are CCL26 and REL, both previously associated with asthma (see Heiman, A. S., Abonyo, B. O., Darling-Reed, S. F. & Alexander, M. S. Cytokine-stimulated human lung alveolar epithelial cells release eotaxin-2 (CCL24) and eotaxin-3 (CCL26). J. Interferon & Cytokine Res. 25, 82-91 (2005); Provost, V. et al. CCL26/eotaxin-3 is more effective to induce the migration of eosinophils of asthmatics than CCL11/eotaxin-1 and CCL24/eotaxin-2. J. Leukocyte Biol. 94, 213-222 (2013); and Donovan, C. E. et al. NF-κB/Rel transcription factors: c-Rel promotes airway hyper-responsiveness and allergic pulmonary inflammation. J. Immunol. 163, 6827-6833 (1999)). These two genes are also consistently perturbed in the same direction (FIG. 7b). At the same time, several genes, like IL13RA1 or STATE, are up-regulated in some patients, and down-regulated in others, suggesting that for these genes the direction of the perturbation is secondary for the disease association. A possible biological interpretation could be that these genes correspond to tightly regulated checkpoints with in pathway, such that any deviation from the homeostatic level would result in a disease-associated perturbation, regardless of the direction of the deviation.

We next determined the Jaccard similarity of the respective individual perturbed pathway genes for each pair of subjects whose PEEPs are significantly enriched with genes of the pathway. The low similarity values (J˜0.1, FIG. 7c) confirm that although all considered subjects show significant perturbations in these asthma-specific pathways, the specific perturbations differ greatly between subjects. These differences limit the power of group-wise DE gene sets to detect affected pathways. As shown in FIG. 15, group-wise DE genes cover only a small fraction of the asthma-related pathways: only seven out of 35 pathways show nominally significant enrichment (uncorrected p-value <0.05, Fisher's exact test), after Bonferroni correction only two pathways remain. Taking individual perturbation profiles into account thus considerably boosts the ability of enrichment analysis tools to identify important disease associated pathways.

We repeated the analysis of the heterogeneity among perturbed pathways also for AD and PD, using general pathway annotations from MSigDB (see Subramanian, A. et al. Gene set enrichment analysis: a knowledge-based approach for interpreting genome-wide expression profiles. Proc. Natl. Acad. Sci. U.S.A. 102, 15545-15550 (2005)) and functional Gene Ontology (GO) (see Ashburner, M. et al. Gene ontology: tool for the unification of biology. Nature Gen. 25, 25-29 (2000)). The results again indicate that the same biological function or pathway is perturbed in different ways in different patients (FIG. 7d-f). These results allow us to formulate our third main result: While patients show considerable perturbation heterogeneity at the PEEP level, they show a high degree of homogeneity at the pathway level. In other words, the different perturbations within a certain molecular pathway lead to similar outcomes, in line with the disease-module hypothesis.

Predicting diseases from PEEPs—Taken together, our results indicate that patients with the same disease exhibit highly heterogeneous perturbations that nevertheless point towards common functional disruptions. This suggests the existence of a broader group of genes, whose perturbations are associated with the specific disease. As demonstrated next, by compiling all genes that are perturbed in a significant fraction of the case subjects, we can accurately predict the disease state of each patient.

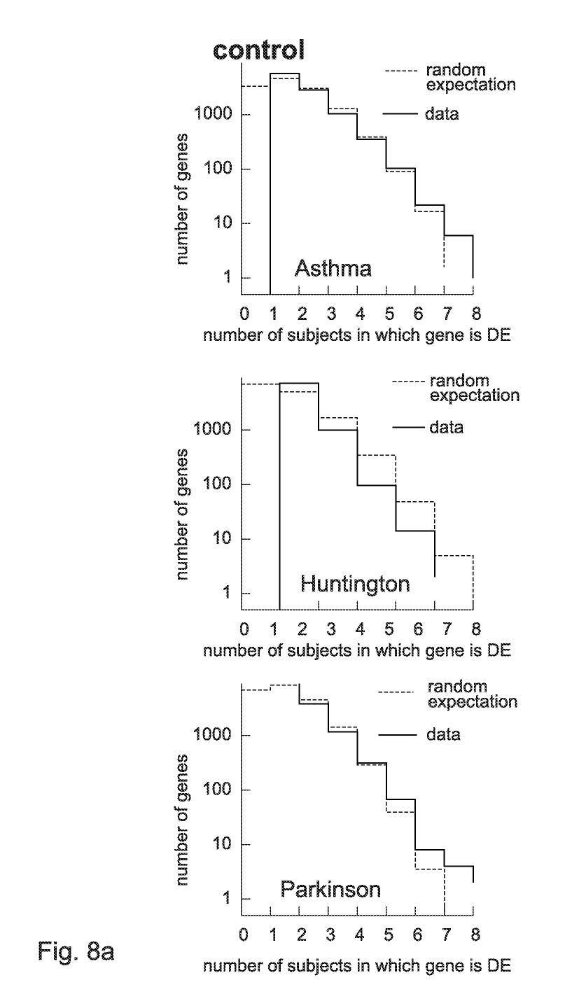

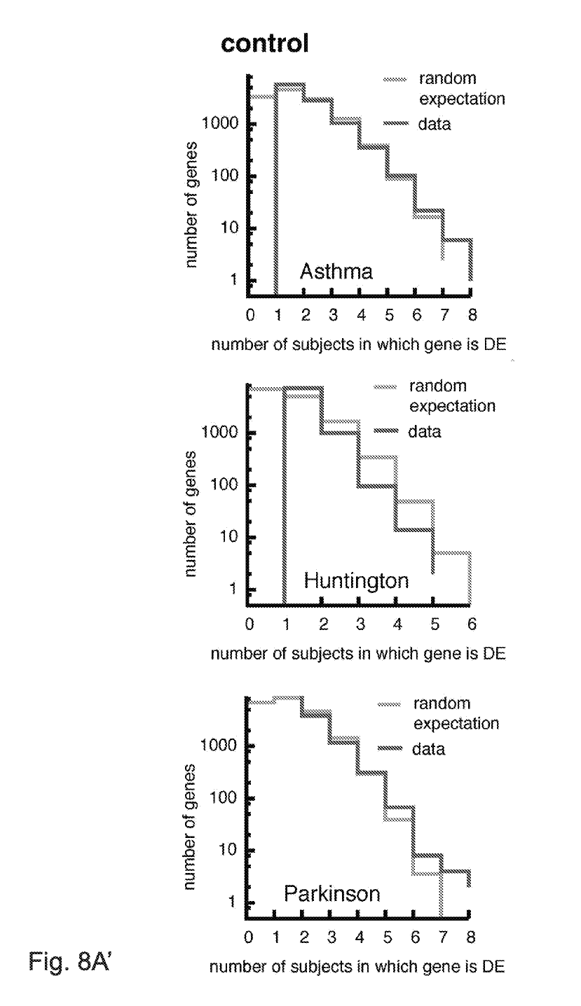

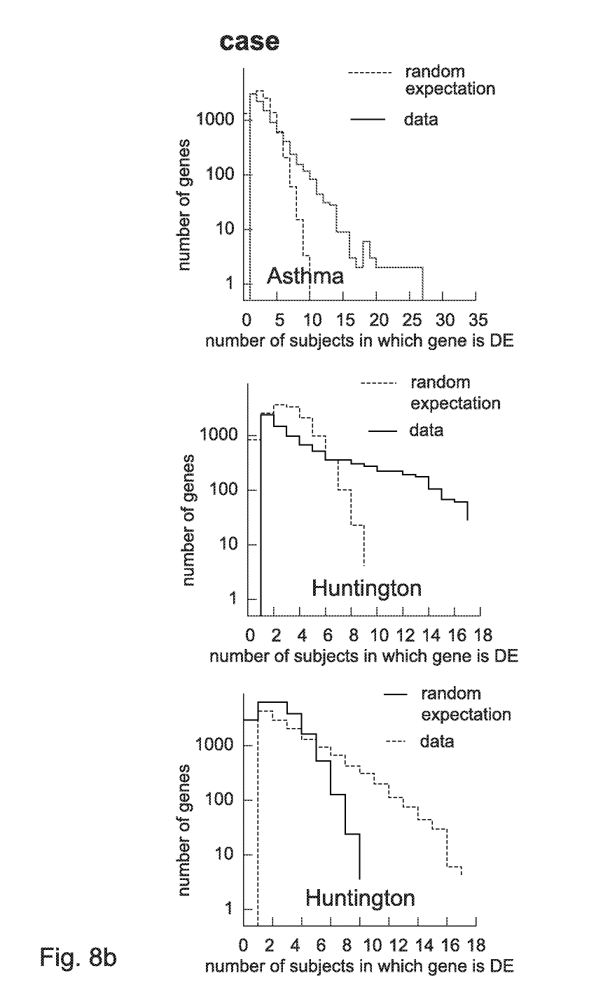

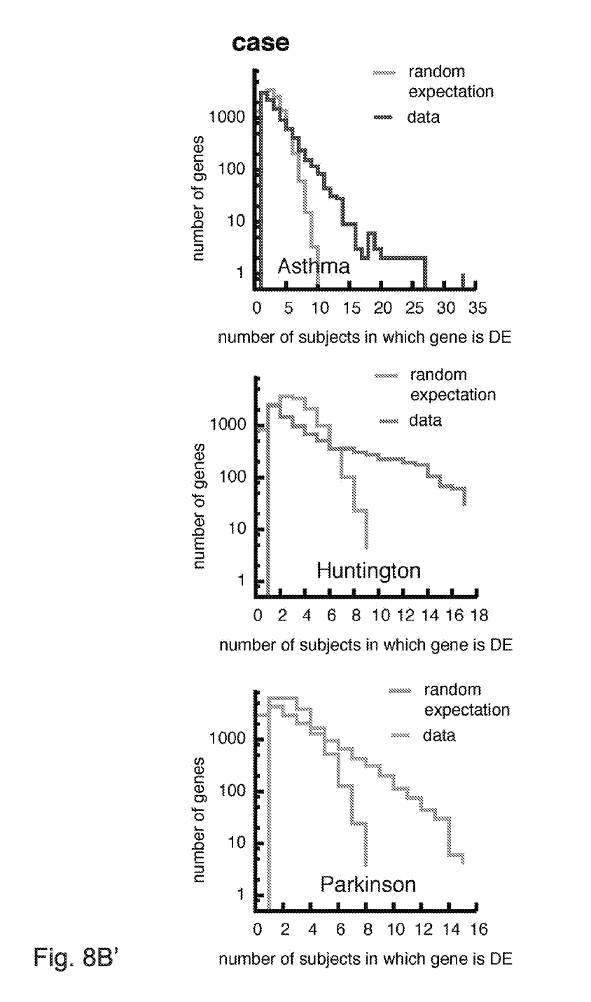

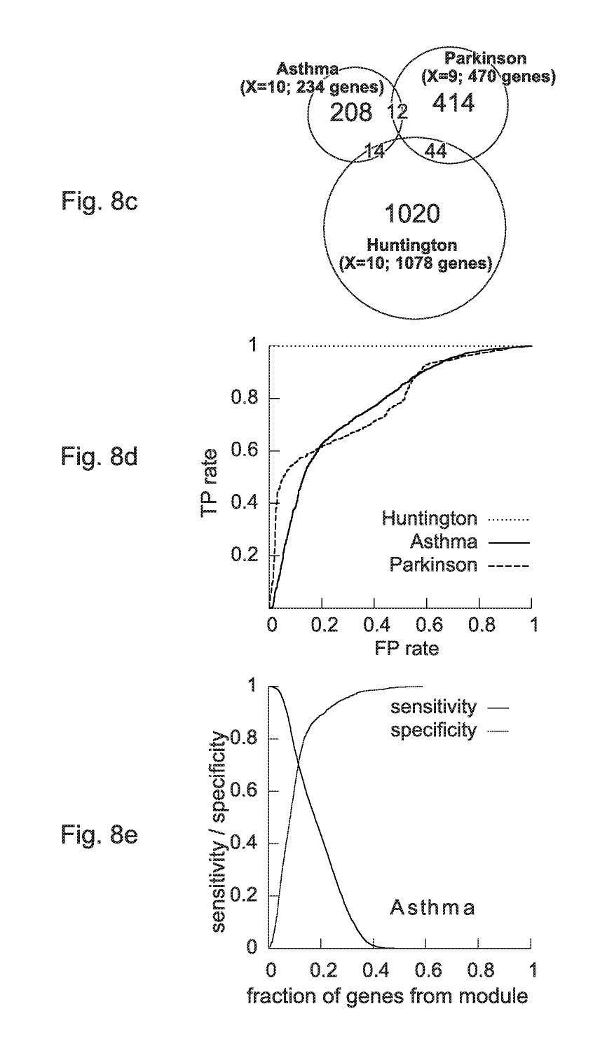

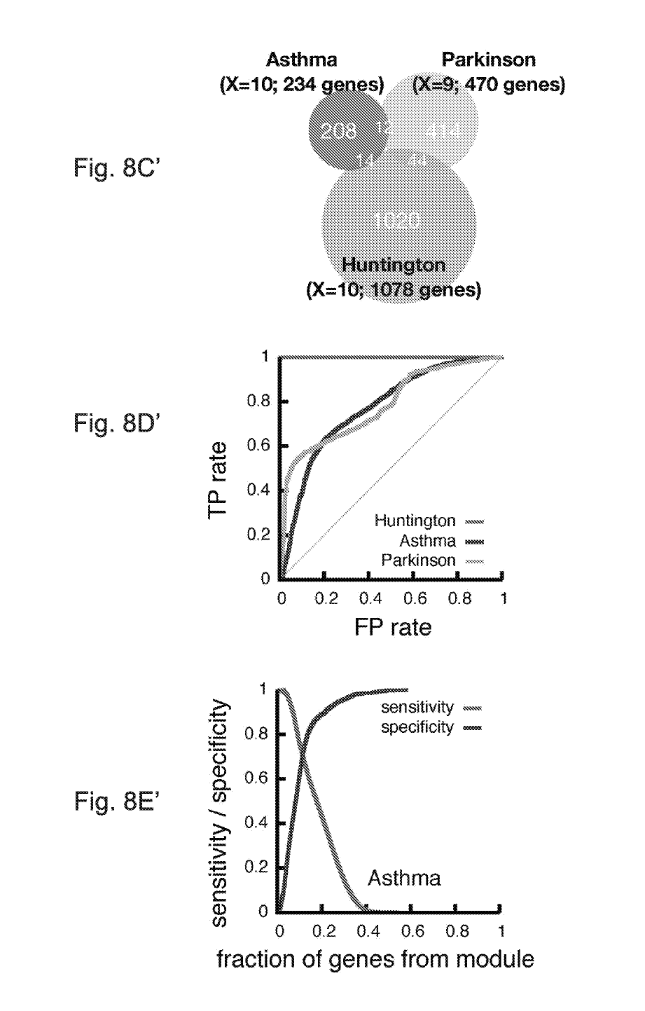

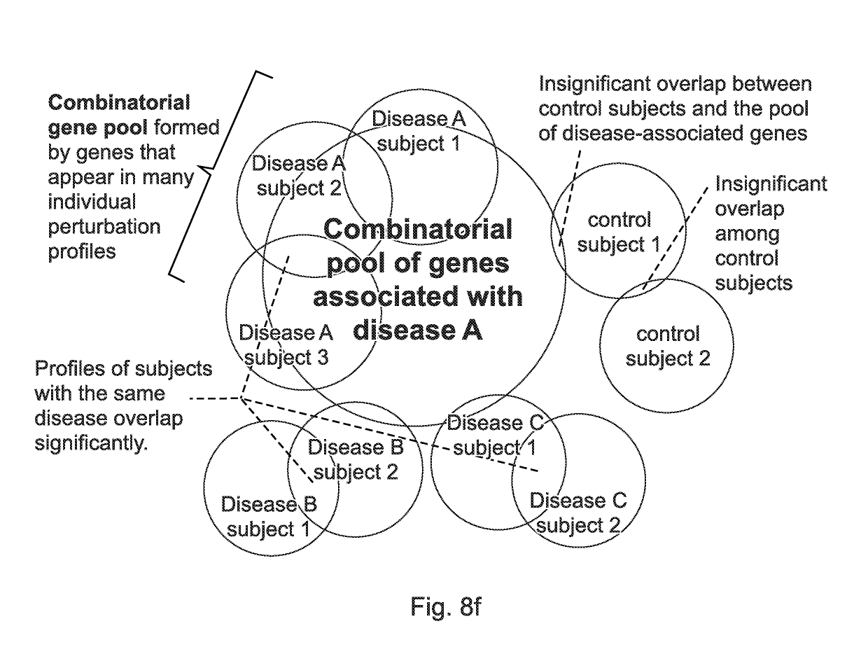

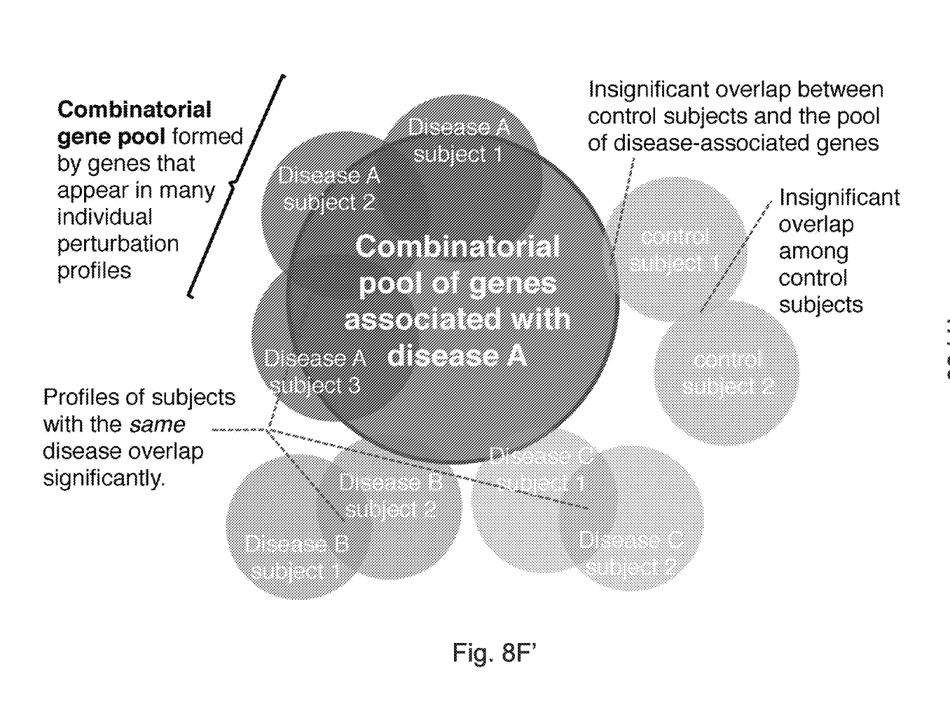

Given the relatively high number of genes perturbed in the individual profiles FIG. 6a), a gene may appear in several subjects simply by chance. Indeed, we find that the number of genes that are shared among control subjects is compatible with random expectation (FIG. 8a). In the healthy control group, possible individual perturbations of the regulatory network are unlikely to be shared among different individuals. For this group, the simplified model of complete independence between subjects is thus a reasonable approximation, as also shown by the good agreement between data and theory reported in FIG. 8a. For case subjects, however, the number of shared genes significantly exceeds the random expectation FIG. 8b). These frequently appearing genes point to the existence of a disease module, a pool of genes whose perturbations are often associated with the disease. Using a combinatorial model, whose basic assumption is that the individual PEEPs constitute random subsets of the disease module (see Methods, below), we can determine the size of this module analytically, obtaining gene pools containing 234 genes for asthma, 470 for PD and 1,076 for HD (FIG. 8c).

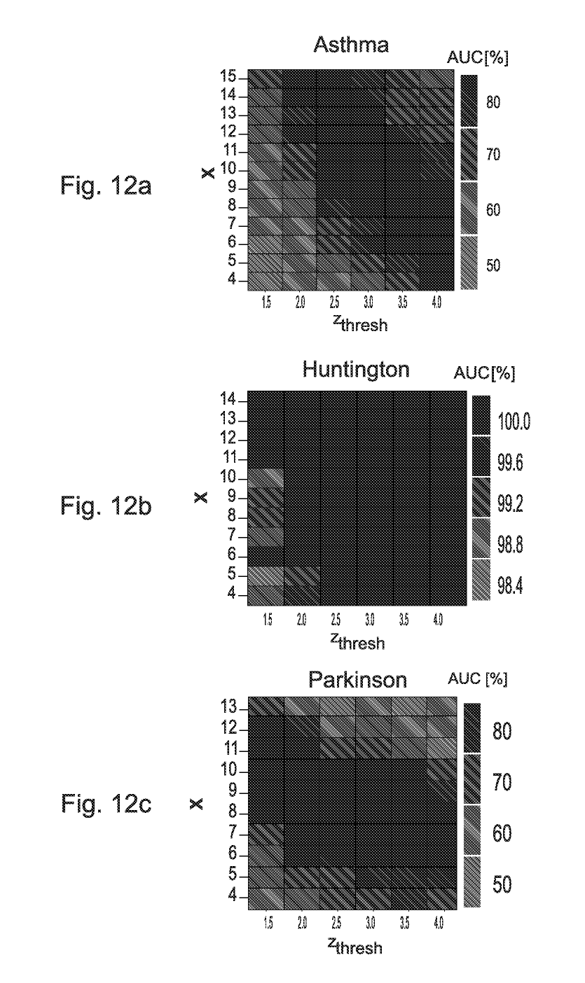

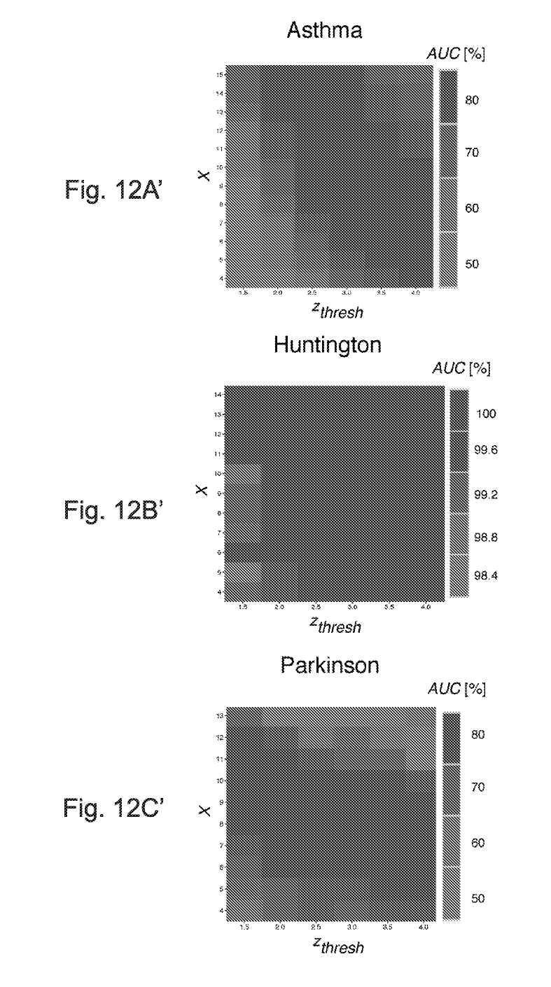

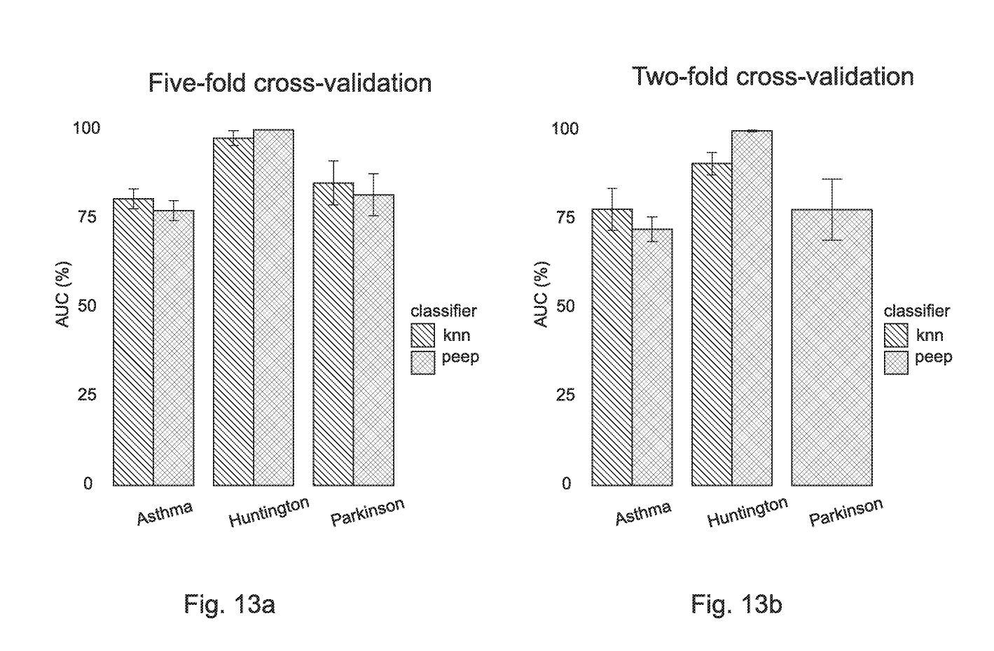

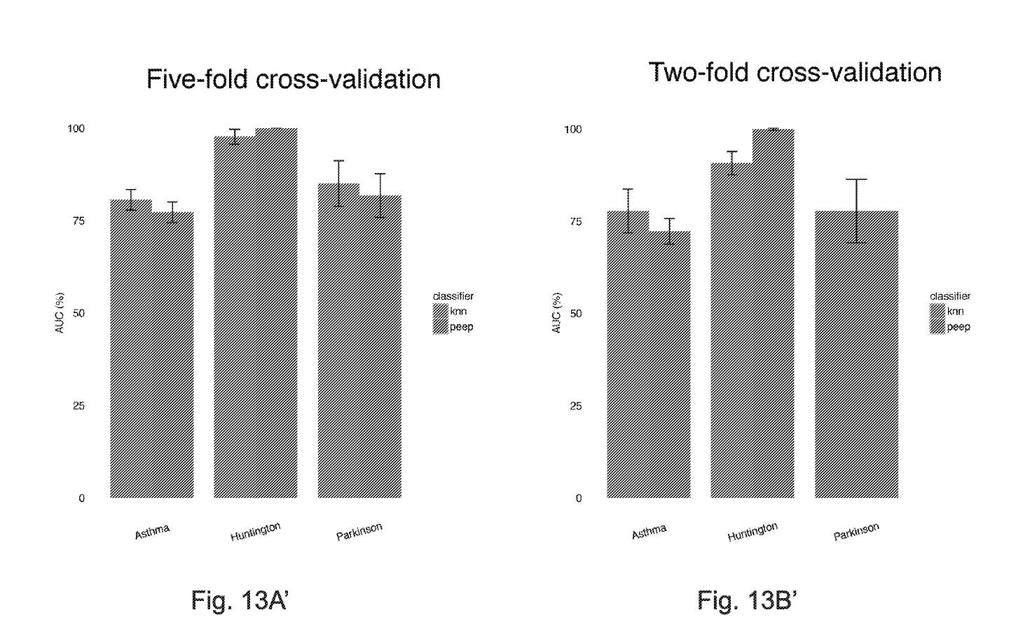

Perturbations of these modules uniquely characterize the respective diseases. To show this, we used a repeated cross-validation approach and determined the different PEEP's overlap with the disease module (see Methods, below). We find that the fraction of genes from the disease module perturbed in an individual subject accurately predicts whether the subject has the disease. For asthma, the PEEPs of case subjects contain on average 21% of the asthma disease pool, compared to less than 7% for the control subjects. For PD and HD the overlap of the case subjects with the corresponding disease modules is much higher, obtaining 65% and 86% respectively, compared to 20% and 6% for the control subjects. This indicates that PD and HD are characterized by a more specific set of characteristic perturbations, while asthma displays a more heterogeneous range of associated perturbations. The receiver operating characteristics (ROC) in FIG. 8d show that the fraction of genes from the general pool that are contained in an individual's perturbation profile can be used as a near highly accurate classifier to distinguish between case and control subjects with high sensitivity and specificity (FIG. 8e). The area under the curve (AUC) values for asthma, PD and HD are 0.77±0.03, 0.81±0.06 and 1.0±0.0 (mean value ±standard deviation computed over 100 cross-validations), respectively. Note that these results were obtained with the threshold zₜₕᵣₑₛₕ=2.5 that we used throughout the manuscript and can be further improved by optimizing zₜₕᵣₑₛₕ and the minimal number of PEEPS X in which a gene must appear to be considered for the disease pool (FIG. 12). We also benchmarked our results against a widely used k-nearest neighbor (knn) classification algorithm (see Slonim, D. K. From patterns to pathways: gene expression data analysis comes of age. Nature Gen. 32, 502-508 (2002)) (see also Methods, below) and find comparable performance (AUC values of 0.80±0.03, 0.85±0.06, and 0.98±0.02 for asthma, PD and HD, see FIG. 13). This not only demonstrates that a classifier based on our combinatorial model offers predictive power similar to the one of state-of-the-art machine learning approaches, but more generally confirms the validity and self-consistency of the basic PEEP concept itself. Indeed, the PEEP concept complements exiting machine-learning approaches as it offers a straightforward biological interpretation of the obtained classification in terms of overlapping perturbation profiles that can also easily be further investigated, using for example gene set enrichment analyses as demonstrated above. Furthermore, the PEEP based classification procedure directly yields a measure for the heterogeneity of the disease, as the combinatorial model explicitly uses the overlap of an individual's PEEP with the broad disease pool to classify the disease status.

Discussion

Group-wise expression analysis has two important limitations: (i) It can only identify genes that are consistently (i.e., in the same direction) perturbed in a large fraction of the patients. (ii) It does not yield patient specific information. Here, we introduced a simple, yet powerful method that overcomes these limitations and offers personalized perturbation profiles, or PEEPs. The method can be interpreted as a generalization of group-wise differential expression methods with PEEPs representing personalized differentially expressed genes. As a consequence, the PEEPs can be easily interpreted and further analyzed using established tools, such as the geneset enrichment analysis used above.

As illustrated in FIG. 8f, the overlap between the genes perturbed in any two patients is relatively small. Indeed, of the three diseases considered here, only HD exhibited genes that were perturbed in all case subjects, likely rooted in the fact that HD is a classic monogenic disease. For asthma and PD, on the other hand, there is not a single gene expressed in the PEEP of all patients.

Despite the high gene level variability, the commonalities at the functional and pathway level indicate that complex diseases arise from disruptions of certain biological processes or disease modules (see Menche, J. et al. Uncovering disease-disease relationships through the incomplete interactome. Science 347, 1257601 (2015)), hence the observed heterogeneity simply reflects the molecular diversity of such disruptions. We therefore expect considerable variability among the expression profiles of subjects with the same disease not despite, but because they all have the same disease. Recently, a number of studies proposed various strategies for dissecting disease heterogeneity, in particular in the field of cancer. The PARADIGM algorithm (see Vaske, C. J. et al. Inference of patient-specific pathway activities from multi-dimensional cancer genomics data using paradigm. Bioinformatics 26, i237-i245 (2010)), for example, infers patient-specific pathways using various omics-type information, such as expression and mutational data, together with curated pathway interactions. Another widespread algorithm, HotNet2 (see Leiserson, M. D. et al. Pan-cancer network analysis identifies combinations of rare somatic mutations across pathways and protein complexes. Nature Gen. 47, 106-114 (2015)) tackles the genetic heterogeneity of different cancer samples using the concept of information propagation starting from known mutations in order to identify cancer-related subnetworks in signaling networks. In this work, we document the existence of large disease module also on other disease areas and using transcriptional data only. We find that a sufficient level of random perturbations among these disease modules can accurately predict the presence/absence of a particular disease. We integrated the personalized profiles of all patients to reconstruct the respective disease module, finding that the fraction of genes in an individual's PEEP is a near perfect predictor for a patient's disease status. This suggests that personalized profiles could identify combinatorial biomarker signatures that go beyond single markers. Methods for constructing a disease module from given seed biomarkers are disclosed in PCT published application no. WO 2015/084461. With next-generation sequencing technology advancing at a fast pace, there is great potential for applying RNAseq technologies to identify transcriptional signatures also in a clinical setting (see Byron, S. A., Van Keuren-Jensen, K. R., Engelthaler, D. M., Carpten, J. D. & Craig, D. W. Translating RNA sequencing into clinical diagnostics: opportunities and challenges. Nature Rev. Gen. 17, 257-271 (2016)). Such signatures are of key importance for personalized medicine and could, for example, help diagnose previously unrecognized diseases. While the results presented here provide first evidence of the general feasibility of using our approach to obtain predictive biomarkers, a comprehensive reference base across all relevant diseases and more extensive tests concerning the robustness and reliability of the resulting disease pools will be required towards an actual clinical application. The observed heterogeneity among the individual perturbation profiles further indicates that single-target drugs may be effective only in a small number of patients. Instead, multi-target strategies may prove more promising for drug development (see Csermely, P., Korcsmáros, T., Kiss, H. J., London, G. & Nussinov, R. Structure and dynamics of molecular networks: a novel paradigm of drug discovery: a comprehensive review. Pharmacology & therapeutics 138, 333-408 (2013)). Our approach can be used to quantitatively assess the expected fraction of patients for which a drug is expected to be effective, helping guide the development of targets with maximal efficacy.

Materials & Methods

Gene expression data—We use data from an ongoing study by Janssen Research & Development for asthma (manuscript in preparation) and previously published expression profiling studies for Huntington's disease and idiopathic Parkinson's disease (see Lesnick, T. G. et al. A genomic pathway approach to a complex disease: axon guidance and parkinson disease. PLoS Genet. 3, e98 (2007)). The asthma dataset contains 55 case subjects with moderate or severe asthma and 25 gender and age matched healthy control subjects (see Silkoff, P. et al. Asthma characteristics and biomarkers from the airways disease endotyping for personalized therapeutics (adept) longitudinal profiling study. Respiratory research 16, 1 (2015) for a detailed description of the cohort). The asthma samples were collected from bronchoscopy (endobronchial biopsies and brushings), preserved immediately in RNAlater® solution and then maintained at −70° C. Qiagen miRNeasy kit (Qiagen; Germantown, Md.) and NuGen ovation pico WTA kit (NuGen Technologies; San Carlos, Calif.) were used to extract and amplify RNA. cDNA is profiled using Affymetrix HG-U133+PMchip (Affymetrix, Santa Clara, Calif.). CEL files were assessed using Almac Diagnostics Microarray Toolbox for quality control (chip image analysis, Affymetrix GeneChip QC, RNA degradation analysis, distribution analysis, principal components analysis, and correlation analysis) and technical outliers are excluded. Robust multi-array (RMA) method is used to re-normalize the profiles, followed by batch effect adjustment via linear modeling of batch (as random factor) and cohort. The Huntington's disease dataset19 (GEO accession number GSE1767) contains analysis of blood samples from 17 case subjects (5 presymptomatic and 12 symptomatic) and 14 control subjects. In HD, the gene expression is suggested to be altered in a variety of tissues including peripheral blood. Affymetrix U133A GeneChips and Amersham Biosciences CodeLink Uniset Human I and II bioarrays were used to analyze the gene expression in blood samples. The Parkinson's disease data (GSE7621) contains 16 case and 9 control subjects for which multiregional gene expression analysis was conducted in postmortem brain using Affymetrix HG U133 Plus 2.0 gene chips. For the PD and HD datasets, the details of the sample generation and expression profiling can be found in the original publications. We reprocessed the raw data set in GEO for Parkinson using RMA with quantile normalization as implemented in the R package ‘affy’. We verified the quality of the data sets by checking the gene expression distribution and sample clustering in PCA. All expression levels in the PD and HD data were log₂ transformed to facilitate direct comparison of the three data, overall results do not depend on the transformation, however. Basic statistics of the used datasets are shown in FIG. 9.

Group-wise differential expression analysis—Genes differentially expressed are identified between case and control subjects using the limma R Bioconductor package (see Smyth, G. K. limma: Linear models for microarray data. In Gentleman, R., Carey, V. J., Huber, W., Irizarry, R. A. & Dudoit, S. (eds.) Bioinformatics and computational biology solutions using R and Bioconductor, 397-420 (Springer, New York, 2005)). The difference between expression levels of case and control subjects are assessed by fitting the expression levels to a linear model using one coefficient for each group in the design matrix. The probesets were mapped to Entrez Gene IDs using the platform annotation files in each data set. In case there were multiple probesets corresponding to the same Gene ID, the probeset with the maximum expression was used in the analysis. The p-values were corrected for multiple hypothesis testing using the Benjamini-Hochberg method (see Benjamini, Y. & Hochberg, Y. Controlling the false discovery rate: a practical and powerful approach to multiple testing. J. Roy. Statist. Soc. Ser. B 289-300 (1995)). At a cut-off of FDR <0.2 we obtain 417, 524, and 7,419 DE genes for asthma, PD and HD, respectively.

Personalized perturbation analysis—To construct the personalized perturbation profile of a subject j we compare the expression level lᵢ^{j} each of its genes i to the reference distribution of expression levels of the same gene within the control group. The extent to which gene i is perturbed in subject j is quantified by the z-score

$${z}_{i}^{j} = \frac{{l}_{i}^{j} - {〈 {l}_{i} 〉}_{cont}}{{σ}_{cont} ( {l}_{i} )} ,$$

that indicates how many standard deviations σ_{cont}(lᵢ) the individual expression level lᵢ^{j} is away from the mean value [symbol] lᵢ [symbol] _{cont} of the control group. Note that if subject j itself is part of the control group, we do not consider it for the computation of the reference distribution but use only the remaining control subjects. We then use a global threshold zₜₕᵣₑₛₕ to define the set of genes that are perturbed in an individual subject. Positive z-scores z^{j}ᵢ>zₜₕᵣₑₛₕ indicate up-regulation, negative values z^{j}ᵢ<−zₜₕᵣₑₛₕ indicate down-regulation. The role of zₜₕᵣₑₛₕ is thus analogous to the one of cutoffs for calling differential expression in standard group-wise analyses. Higher zₜₕᵣₑₛₕ values result in smaller, more stringent PEEPs that potentially miss out relevant genes with less pronounced perturbations, while lower zₜₕᵣₑₛₕ values provide a more global picture that may, however, also contain an increased number of false positives. The precise choice of zₜₕᵣₑₛₕ can be optimized for specific purposes, such as disease patient classification (compare with FIG. 12).

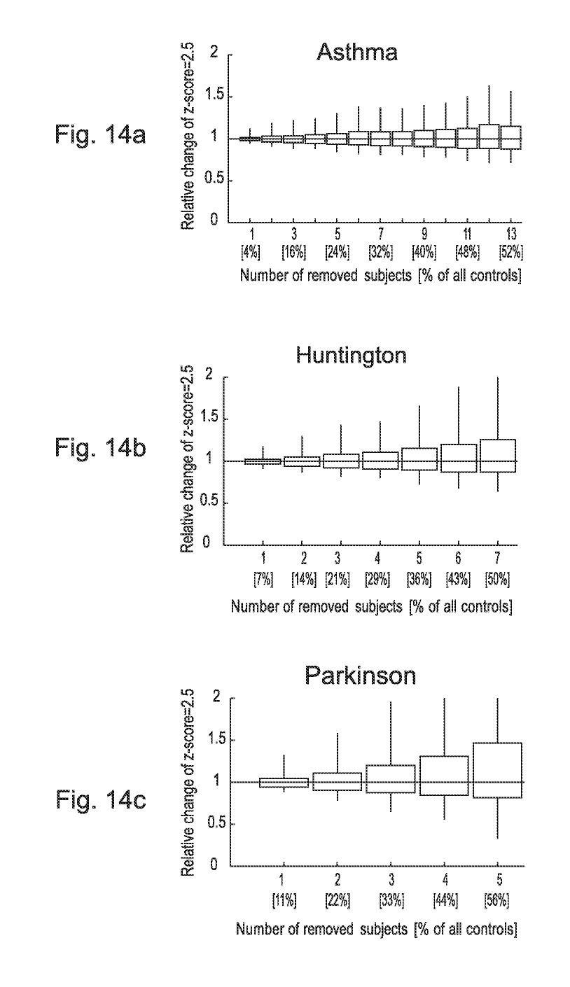

We systematically evaluated the stability of the obtained z-scores against changes in the population size by removing increasing numbers of subjects from the control population: We first calculated the expression level that corresponds to z-score=2.5 compared to the average mean and standard deviation of all genes and all control subjects. We then observed how the z-score of this expression level changes while randomly removing an increasing number of subjects from the pool of control subjects (up to 50% of the original population). For each gene, we then calculated the ratio of the z-score obtained from the decreased population to the original z-score calculated from the original population. FIG. 14 shows that for small numbers of removed subjects the fluctuations are very small, indicating stable z-scores. As expected, the fluctuations grow, as more and more subjects are removed. We conclude that all considered datasets have a sufficient number of control subjects in order to yield reliable perturbation profiles. Conversely, the data suggests that increasing population sizes can further stabilize the PEEPs, ultimately converging into a fixed pool of disease-specific genes.

Analytical comparison with randomly distributed genes—To determine the minimal number X of case subjects in which a gene must be perturbed in order to be collected into the global pool of disease associated genes we use a comparison with random expectation. We consider a null model where each subject has g perturbed genes that are drawn completely at random from all G genes. The probability for one gene to be perturbed in exactly k out of n subjects is then given by the binomial distribution

$$f ( k ; n , p ) = Pr ( x = k ) = ( \begin{matrix}n \\ k\end{matrix} ) {{p}^{k} ( 1 - p )}^{n - k}$$

with p=g/G. Using the mean number of genes observed in the individual profiles for g, the histogram of the number of subjects per gene can now be obtained by simply multiplying G×f(k; n, p). We find excellent agreement between this formula and the distributions observed among the control subjects, but, as expected, not for case subjects (FIGS. 8a and 8b). The maximal number of subjects X_{rand} that are expected per gene according to this random model can be obtained from

$${\sum }_{k = {X}_{rand}}^{n} Gf ( k ; n , p ) < 1 ,$$

which can be solved by simply testing increasing values. Finally, we choose the minimal value as X=X_{rand}+1, thereby ensuring a broad, yet high-quality pool of disease-associated genes. The calculated values are X=10 for asthma, X=9 for PD, and X=10 for HD.

Cross-validation analysis for disease state prediction—We performed a five-fold cross-validation analysis using the fraction of genes of the combinatorial pool of disease-associated genes that is contained in a subject's personal perturbation profile to predict the disease state of the subject. Note that we do not take the direction of the perturbation into account. If the fraction is larger than a given threshold that can be determined from the training data we classify the subject as “case,” otherwise as “control.” This threshold not only allows for patient classification, but can also be interpreted as a direct measure of the heterogeneity of a disease. For the cross-validation, we randomly split the subjects into five groups having similar proportions of cases and controls as in the full dataset. We then iteratively use each group as the validation set and the remaining four groups as training data to generate the PEEPs and the combinatorial disease pool. Next, we calculate the fraction of the combinatorial pool that is contained in the PEEP of each subject in the validation set. By using all identified fractions as putative thresholds for classification as “case” or “control” and comparing with the true labels we then construct the ROC (receiver operating characteristic) curve and calculate the AUC (area under the curve). Note that the classifier is completely blind to the information of the left-out validation subjects, thus avoiding overfitting due to the fact that the combinatorial pool itself is compiled from all genes that are perturbed in X or more case subjects. The entire procedure is repeated 100 times to get robust estimates of the ROC curve and the AUC.

We further compared the performance of the PEEP-based classification to a k-nearest-neighbor (kNN) based classification. For every sample in the test set we calculated the gene expression correlation with all samples in the training set and then ranked the training samples according to the strength of the correlation. The known disease states of the k most similar samples (i.e., highest correlation) is then used to score the test sample's likelihood to belong to the same class. After evaluating a range of values of k (=3, 5, 10, 15, 20) we found k=15 to offer the highest prediction accuracy. Note that while the kNN method allows for a high-quality classification, the subsequent interpretation of a classification result is less straightforward compared to the PEEP approach above, which is directly based on overlapping gene sets that can be immediately further investigated and potentially validated.

To estimate the influence of the sample size on the final accuracy of the classification analysis, we further repeated both the kNN and the PEEP-based classification using a two-fold validation scheme, such that only half of the case and control subjects are available for training. The results shown in Supplementary FIG. 5 demonstrate that both approaches are rather robust against variations in the sample size (AUC values for the PEEP-based approach are 0.72, 0.78, and 1.0 for asthma, PD and HD, respectively).

Functional gene annotation data—To analyze the biological function of genes and gene sets, we can use Gene Ontology (GO) terms, general pathway annotations and asthma-specific pathways. GO annotations were downloaded from http://www.geneontology.org/. We only use high confidence annotations associated with the evidence codes EXP, IDA, IMP, IGI, IEP, ISS, ISA, ISM or ISO and further remove all associations with a non-empty “qualifier” column (see Berriz, G. F., Beaver, J. E., Cenik, C., Tasan, M. & Roth, F. P. Next generation software for functional trend analysis. Bioinformatics 25, 3043-3044 (2009)). Since the provided GO files only contain the most specific annotations explicitly, we add all implicit more general annotations by up-propagating the given annotations along the full GO tree.

The general pathway annotations were taken from the Molecular Signatures Database (MSigDB) published by the Broad Institute, Version 4.0. MSigDB integrates several pathway databases; we use those from KEGG, Biocarta, and Reactome. Asthma-specific pathways (FIG. 15) were compiled using the GeneGo Software.

Gene set enrichment analysis—The enrichment analysis between a given gene set and a pathway or GO annotation (“term”) may be accomplished using Fisher's exact test. We considered a term to be significantly enriched if p-value <0.05 (Bonferroni correction for number of tested terms). For each bar in FIGS. 7d-f, we first determined all terms that are significantly associated with the genes in the individual profile of at least three case subjects. For each significant term, we then computed the Jaccard index for all possible pairs of subjects with profiles enriched with the respective term. Note that we use only the genes associated with the respective term to compute the Jaccard index. Finally, we combine all Jaccard values of all pairs and all GO terms into one distribution, which is represented by the whisker bars.

R-package—We provide the R package “PePPeR” (Personalized Perturbation ProfileR) which includes functions to fetch expression data sets from the GEO database, identify group-wise DE genes and construct individual perturbation profiles. The R package along with its documentation is available at https://github.com/emreg00/pepper.

FIG. 16 illustrates a computer network or similar digital processing environment in which embodiments of the present invention may be implemented. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60, via communication links 75 (e.g., wired or wireless network connections). The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

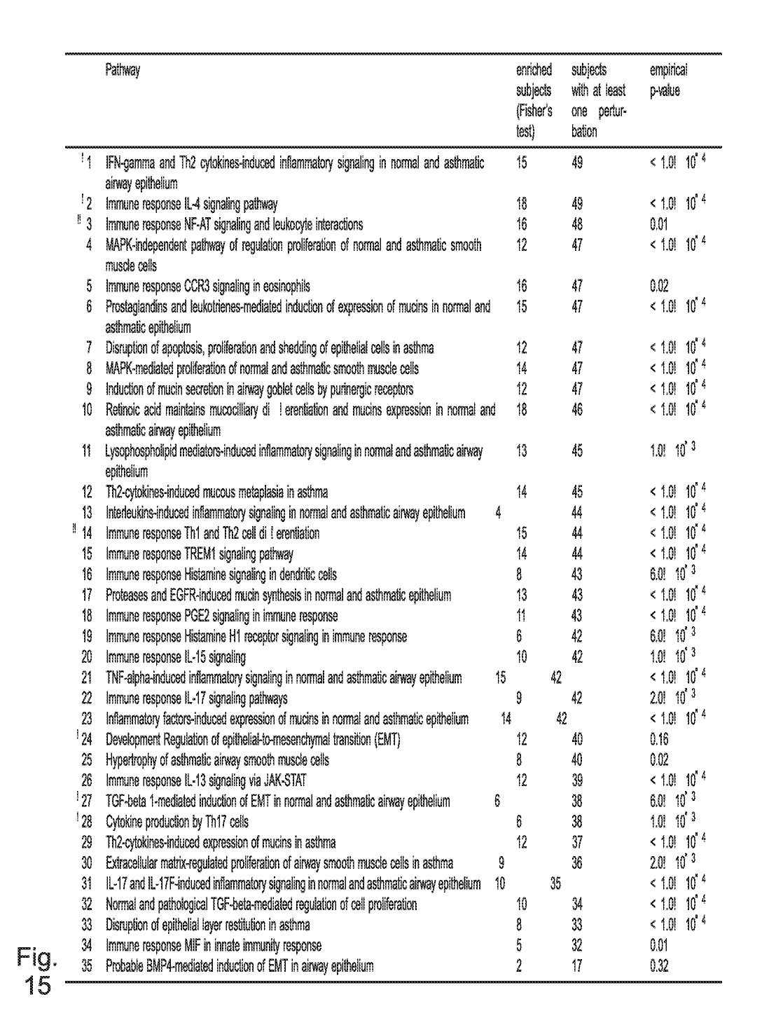

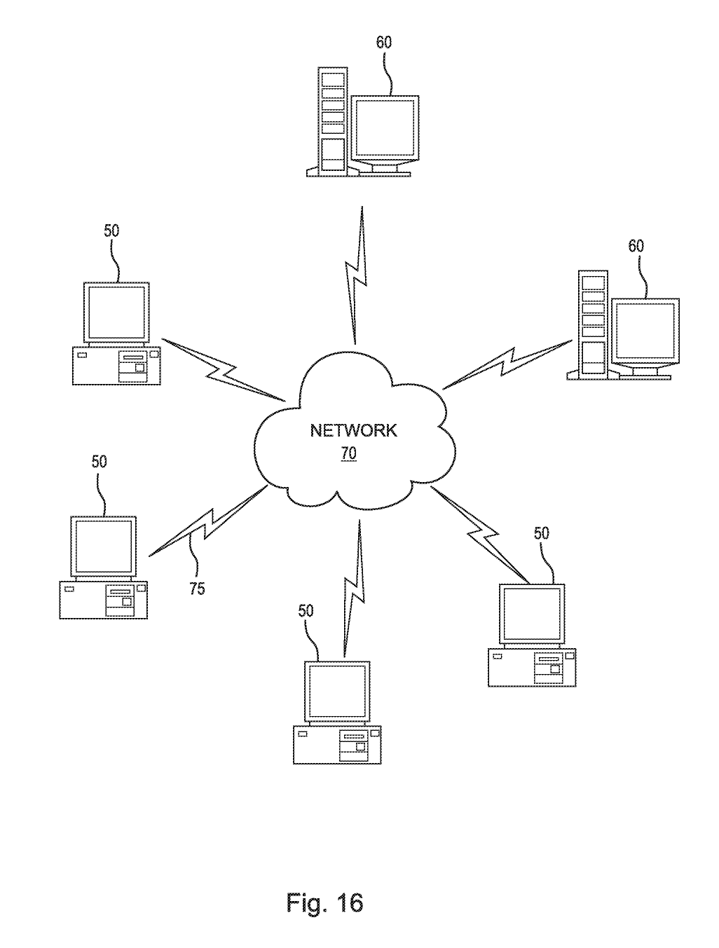

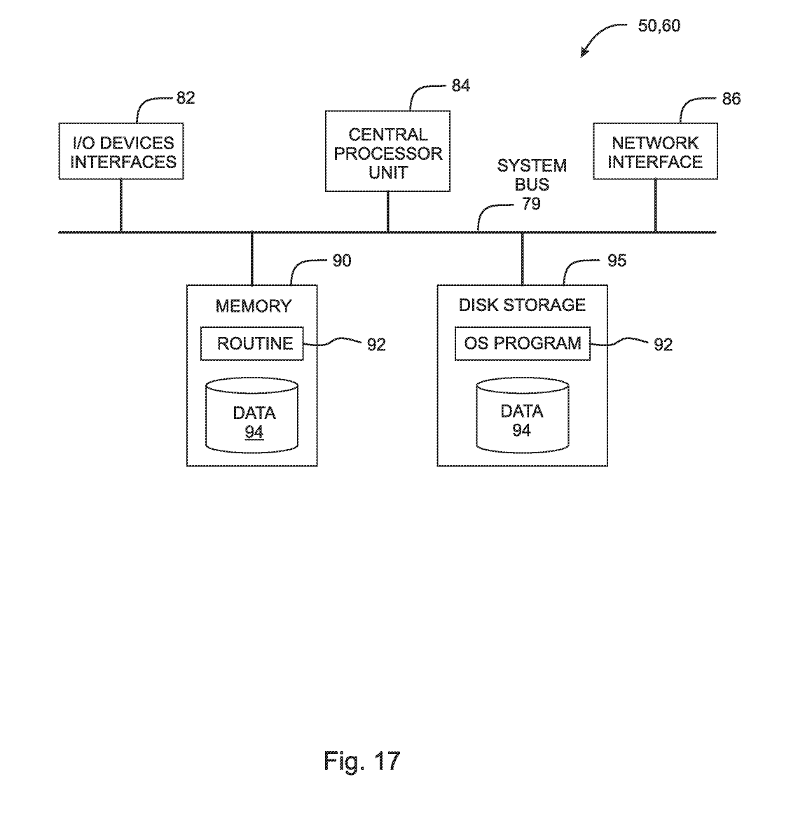

FIG. 17 is a diagram of an example internal structure of a computer (e.g., client processor/device 50 or server computers 60) in the computer system of FIG. 16. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 16). Memory 90 provides volatile storage for computer software instructions 92 and data 94 used to implement an embodiment of the present invention. Disk storage 95 provides non-volatile, non-transitory storage for computer software instructions 92 and data 94 used to implement an embodiment of the present invention. A central processor unit 84 is also attached to the system bus 79 and provides for the execution of computer instructions. The disk storage 95 or memory 90 can provide storage for a database. Embodiments of a database can include a SQL database, text file, or other organized collection of data. In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection.

While this invention has been particularly shown and described with references to example embodiments thereof, it will be understood by those skilled in the art that various changes in form and details may be made therein without departing from the scope of the invention encompassed by the appended claims.

1-5. (canceled)

6. A method of classifying the disease state of a subject, the method comprising:
detecting differential expression of one or more analytes or genes in a subject to obtain a personalized perturbation profile for the subject; and
determining the fraction of analytes or genes from a disease module that are differentially expressed in the personalized perturbation profile for the subject, thereby characterizing the disease state of the subject.

7. The method of claim 6, wherein a fraction greater than about 15% or 20% indicates the presence of the disease in the subject.

8. The method of claim 6, where a fraction greater than about 50%, 65%, or 85% indicates the presence of the disease in the subject.

9. The method of claim 6, wherein the disease is a neurodegenerative disease.

10. The method of claim 6, wherein the disease is Parkinson's Disease or Huntington's Disease.

11. The method of claim 6, wherein the disease is asthma.

12. The method of claim 6, wherein the fraction defines a subset of patients within the disease module having similar personalized perturbation profiles.

13. A method of determining whether the subject has the disease, the method comprising:
detecting differential expression of a plurality of genes in an individual case subject relative to the expression levels of the genes in one or more control subjects, thereby obtaining a personalized perturbation profile for the subject;
compiling the personalized perturbation profile from each subject across a population of case subjects; and
comparing the compiled personalized perturbation profiles with a set of genes whose differential expression is associated with said disease and generating a statistical score; thereby determining whether the subject has the disease.

14. The method of claim 13, wherein the statistical score defines a subset of patients within the disease module having similar personalized perturbation profiles.

15. The method of claim 6, wherein the analyte is detected in a biological sample of the subject.

16. The method of claim 15, wherein the analyte is mRNA, a methylated nucleotide, protein, peptide, lipid, carbohydrate, or a metabolite.

17-34. (canceled)

35. A method for determining a disease state of a patient, the method comprising:
generating personalized biomarker expression perturbation profiles for a plurality of individual subjects with a disease, the personalized biomarker expression perturbation profiles including representations of biomarker expressions that are perturbed beyond a threshold amount, the biomarker expressions being associated with gene expression levels for the plurality of individual subjects;
creating a disease module by combining representations of biomarkers from the personalized biomarker expression perturbation profiles, the disease module including a network of representations of biomarkers having perturbations associated with the disease;
accessing biomarker data including representations of biomarker expressions for the patient from a sample obtained from the patient; and
determining the disease state of the patient based on a comparison of the biomarker data and the disease module.

36. A method as in claim 35 wherein generating the personalized biomarker expression perturbation profiles includes comparing representations of biomarker expressions of the individual subjects with reference biomarker expression levels of a control group, and selecting for inclusion in the personalized biomarker expression perturbation profiles representations of biomarkers having expression levels exceeding corresponding biomarker expression levels of the control group by the threshold amount.

37. A method as in claim 35 wherein creating the disease module includes determining a number of random biomarker perturbations expected for the disease, and including a number of representations of biomarkers in the disease module that is greater than the expected number of random biomarker perturbations.

38. A method as in claim 35 wherein determining the disease state of the patient includes matching representations of perturbed biomarkers of the biomarker data with the representations of biomarkers of the disease module.

39. A method as in claim 38 wherein determining the disease state of the patient includes determining that the patient has the disease if a number of representations of perturbed biomarkers of the biomarker data matching representations of biomarkers of the disease module exceeds a threshold level.

40-45. (canceled)
